(19) United States
(12) Patent Application Publication
(10) Pub. No.: US 2003/0038931 A1
(43) Pub. Date: Feb. 27, 2003

(54) Illumination optical apparatus, exposure apparatus and method of exposure

(75) Inventors: Mitsunori Toyoda, Fukaya-shi (JP); Osamu Tanitsu, Kumagaya-shi (JP); Yuichiro Takeuchi, Minato-ku (JP); Shigeru Hirukawa, Kita-ku (JP); Kyoichi Suwa, Totsuka-ku (JP); Toshiharu Nakashima, Chiyoda-ku (JP)

Correspondence Address: OLIFF & BERRIDGE, PLC, P.O. BOX 19928, ALEXANDRIA, VA, 22320, US

(73) Assignee: NIKON CORPORATION, Tokyo (JP)

(21) Appl. No.: 10/223,607

(22) Filed: Aug. 20, 2002

(30) Foreign Application Priority Data
Aug. 23, 2001 (JP) 2001-252363
Aug. 23, 2001 (JP) 2001-252961

(51) Int. Cl. G03B 27/54

(52) U.S. Cl. 355/67; 355/68; 355/55; 355/53; 355/71

(57) ABSTRACT

An exposure apparatus with optimum illumination conditions without dependence on the directionality of the fine pattern on a reticle comprises an illumination optical system for illuminating a reticle having a pattern to be transferred and a projection optical system for projecting and transforming the reticle pattern on a substrate. The illumination optical system has pupil shape forming unit for forming four substantially planar light sources on the plane in the vicinity of its pupil. These four substantially planar light sources are arranged at each substantial vertices of a narrow rectangle whose barycenter is located on the illumination optical axis.

### BACKGROUND OF THE INVENTION

1. Field of the Invention

The present invention relates to an illumination optical apparatus, an exposure apparatus and method of exposure for manufacturing micro devices, such as semiconductor elements, flat panel displays such as liquid crystal display elements, image pick-up elements such as CCD, thin film magnetic heads, and the like, by means of photolithographic processing.

2. Related Background Art

In a typical exposure apparatus, light (radiation) beam emitted from a light (radiation) source is input to a fly-eye lens, and a secondary light source consisting of multiple light sources is formed on the rear side focal plane thereof. The light beam from the secondary light source is limited by an aperture provided in the vicinity of the rear side focal plane of the fly-eye lens, and is then input to a condenser lens. The aperture restricts the secondary light source to a prescribed shape or size, according to prescribed illumination conditions (exposure conditions).

The light beam that is collected by the condenser lens is directed in over lapping manner to a reticle (mask) formed with a prescribed pattern. The light that has passed through the reticle pattern is imaged on a wafer after passing through a projection optical system. The reticle pattern is therefore produced on the wafer by projection and exposure (transfer). It should be noted that the pattern formed on the reticle has a high density of integration and it is essential for precise transfer of this fine pattern onto the wafer that a uniform distribution of illuminance should be obtained on the wafer.

### SUMMARY OF THE INVENTION

In recent years, attention has focused on techniques for changing the illumination coherency σ (where σ value=aperture diameter/optical diameter of image forming optics, or σ value=numerical aperture at output side of illumination optics/numerical aperture at input side of image forming optics), by changing the size of the opening (light transmitting section) of the aperture provided on the output side of the fly-eye lens. Moreover, attention has also been paid to techniques for limiting the shape of the secondary light source formed by the fly-eye lens to an annular shape or quadrupolar shape, thereby improving the focal depth and resolution of the image forming system, by designing the opening section of the aperture provided on the output side of the fly-eye lens with a ring shape, or a four-holed shape (in other words, a quadrupolar shape).

In order to perform reshaped illumination (annular or quadrupolar illuminated) by restricting the secondary light source to an annular or quadrupolar shape, if the light beam from a relatively large secondary light source formed by a fly-eye lens is simply restricted by an aperture with an annular or quadrupolar opening section, then the corresponding portions of the light beam from the secondary light source will be shut out and will not contribute to illumination (exposure). Therefore, the illumination intensity on the mask and wafer is reduced by the light loss in the aperture section, and hence the through-put of the exposure apparatus is degraded.

Therefore, a composition has been conceived, for example, wherein light beam previously converted to an annular shape or quadrupolar shape by a diffractive optical element is input to the fly-eye lens, thereby forming an annular or quadrupolar secondary light source on the output side of the fly-eye lens. In this case, an annular or quadrupolar illumination field is formed on the input side of the fly-eye lens, by the diffractive optical element, and consequently, a secondary light source having substantially the same light intensity distribution as the illumination field (for example, an annular or quadrupolar distribution) is formed on the rear side focal plane of the fly-eye lens, which means that the light loss caused by the aperture can be reduced.

Here, if the central axis of the light beam from the light source is inclined with respect to the reference optical axis of the illumination optical system, in other words, if the central axis of the light beam is inclined with respect to the optical axis of the diffractive optical element, then the position of the illumination field formed on the input side of the fly-eye lens will be displaced from the prescribed reference position. Consequently, the position of the secondary light source formed on the rear side focal plane of the fly-eye lens will also be displaced from the prescribed reference position, and hence the telecentricity of the light beam on the illumination object (mask) will be upset.

Moreover, a composition has also been conceived wherein a pair of V-grooved axicon (V-shaped axicon) systems are placed with their ridge lines oriented orthogonally with respect to each other in the optical path between the diffractive optical element and the fly-eye lens. In this structure, a cross-shaped shadow of low intensity is formed on the input side of the fly-eye lens, due to the ridge sections of the pair of V-grooved axicon systems. In this case, if the width of the vertical shadow formed by one of the V-grooved axicon systems is substantially different to the width of the horizontal shadow formed by other of the V-grooved axicon systems, then a problem arises in that the pattern transferred onto the wafer will have different line widths in the vertical direction and the horizontal direction. Moreover, a structure has been proposed wherein a conical axicon system is placed in the optical path between the diffractive optical element and the fly-eye lens, and in this structre, a spot-shaped shadow of low intensity is formed on the input face of the fly-eye lens, due to the vertex portion of the conical axicon system. In this case, if the position of the conical shadow departs from the optical axis, then the telecentricity of the light beam on the illumination object (mask) is upset, and hence a problem arises in that the line width of the pattern transferred onto the wafer is different in the vertical direction and horizontal direction.

Further, with the related art techniques described above, it was not possible to achieve optimum illumination conditions with no dependence on directionality of the fine pattern on the reticle.

In view of the above, it is a first object of the present invention to provide an exposure apparatus and exposure method capable of performing exposure under optimum illumination conditions with no dependence on the directionality of the fine pattern on the reticle. And a second object of the present invention being to align the position of the central axis of the light beam from the light source with respect to the reference optical axis of the optical system.

For achieving the first object, the exposure apparatus according to the present invention is apparatus for transferring a pattern of a mask onto a workpiece, comprising: a light source; an illumination optical system, which illuminates the mask, arranged in an optical path between the light source and the mask and comprising a pupil shape forming unit which forms four substantially planar light sources at a predetermined plane orthogonal to the illumination optical path in the vicinity of the pupil thereof, wherein the four planar light sources are arranged at each substantial vertices of a narrow rectangle whose barycenter is located on the optical axis so as to adjust a resist pattern to be transferred or a substrate pattern formed via a process to a predetermined size and a predetermined shape; and a projection optical system arranged in an optical path between the mask and the workpiece.

By arranging these planar light sources at vertices of a narrow rectangle, and controlling the shape of this narrow rectangle, the resist pattern that is transferred or the substrate pattern (wafer pattern) that is formed by processing (wafer processing) can be produced in a desired size and shape.

When the reticle has a plurality of chip patterns, the narrow rectangle which is the reference for arranging the planar light sources is disposed such that at least one of a longer side of the narrow rectangle and a shorter side of the narrow rectangle is set based on a longer direction of the chip pattern. The exposure can be performed in accordance with optimum illumination conditions without dependence on the directionality of the fine pattern on the reticle.

The pupil shape forming unit of the exposure apparatus according to the present invention may have first and second illumination mode for arranging the four planar light sources. The longer side of the narrow rectangle which is the reference for arranging the planar light sources in the second illumination mode extends along the direction which the shorter side of that in the first illumination mode extends. And a ratio between longer side and shorter side of the rectangle in a first illumination mode may be 1.1 or more, and a ratio between shorter side and longer side of the rectangle in a second illumination mode maybe 1/1.1 or less.

By using this pupil shape forming unit, the optimum illumination conditions are obtained if the direction of the fine pattern on the reticle differs other reticle.

One barycenter position of the four planar light sources (r, θ) in polar coordinates whose origin is located at illumination optical axis, and r is normalized with a pupil radius of the projection optical system as 1, may be satisfied following conditions in first illumination mode,

0.5<r<1−rs

sin⁻¹{(rs)/(1−rs)}<θ<Π/4

where rs is the distance from the barycenter position of the one planar light source to the outermost circumferential edge, and

may be satisfied following conditions in the second illumination mode.

0.5<r<1−rs

Π/4<θ<Π/2−sin⁻¹{(rs)/(1−rs)}

For achieving the second object, the illumination optical device according to the present invention comprises an optical integrator arranged in an illumination optical path and forming a large number of light sources on the basis of a light beam from a light source; a guiding optical system arranged in an illumination optical path between the optical integrator and a irradiated face and directing a light beam from the optical integrator to an irradiated face; a illumination field forming optical system, which includes a light beam converting element disposed in the optical path between the light source and the optical integrator which converts the light beam from the light source to light beam having a predetermined cross-sectional shape or a predetermined light intensity distribution, forming a illumination field with a predetermined positional relationship with respect to the optical integrator in response to the light beam emitted from the light beam converting element; a light splitting member disposed on the optical path between the predetermined plane and the light beam converting element; a photoelectric converter element disposed on substantial conjugate plane of the predetermined plane and receiving light beam split by the light splitting member; and a calculating unit, connected to the photoelectric converter element, and which determines a positional relationship between the light beam from the light source and the predetermined plane in response to the output of the photoelectric converter element.

According to this illumination optical device, the center axis of the light beam from the light source is finely aligns at the center axis of the optical path of the optical system. So the exposure apparatus including this illumination optical device can make the micro device in good illuminating condition.

The present invention will be more fully understood from the detailed description given hereinbelow and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

FIGS. 1A to 1C are views for explanation of optimum quadrupole illumination in the manufacture of a triple DRAM chip;

FIGS. 2A to 2C are views for explanation of optimum quadrupole illumination in the manufacture of a quadruple DRAM chip;

FIGS. 3A and 3B are views for explanation of the mode of quadrupole illumination assumed in a simulation;

FIG. 4 is a view for explanation of the layout of a pattern assumed in the simulation;

FIGS. 5A, 6A and 7A are diagram showing the spatial image of best focus under the illumination condition with changing Y position of each planar light source (surface illuminant) shown as FIGS. 5B, 6B and 7B, respectively, when Y position is 0.82 in FIGS. 5A and 5B, 0.46 in FIGS. 6A and 6B, and 0.40 in FIGS. 7A, and 7B;

FIGS. 8 and 9 are views showing the line width in the longitudinal and transverse direction of the active pattern in each illumination condition and each defocusing condition for different Y positions of each planar light source, respectively;

FIG. 10 is a view showing diagrammatically the construction of an exposure apparatus according to a first embodiment of the present invention;

FIG. 11 is a view showing diagrammatically the construction of a turret wherein a plurality of aperture stops are arranged in circumferential manner;

FIG. 12 is a view showing diagrammatically the construction of an exposure apparatus according to a second embodiment of the present invention;

FIG. 13 is a view showing diagrammatically the construction of a turret wherein a plurality of diffractive optical elements are arranged in circumferential manner;

FIG. 14 is a view showing diagrammatically the construction of an exposure apparatus according to a third embodiment of the present invention;

FIG. 15 is a view showing diagrammatically the construction of an exposure apparatus according to a fourth embodiment of the present invention;

FIG. 16 is an oblique view showing the approximate construction of a pair of axicon systems disposed in an optical path in the fourth embodiment of the present invention;

FIG. 17 is a view showing the co-ordinates of each planar light source on the illumination pupil.

FIG. 18 is an approximate view of the construction of an exposure apparatus as a fifth embodiment of the present invention;

FIG. 19 is an approximate view of the principal construction of the fifth embodiment;

FIGS. 20A to 20C show states where the position of the illumination fields formed on the incident face of the micro lens array is displaced from the prescribed reference position;

FIG. 21 shows a state where a cross-shaped shadow of low intensity is formed on the incident face of the micro lens array due to the ridge line section of a pair of V-grooved axicon systems;

FIGS. 22A to 22C show the illumination fields formed on the light receiving face of a photoelectric converter element, when a diffractive optical element for adjustment is used;

FIG. 23 is an oblique view showing the approximate construction of conical axicon systems disposed in an optical path in the fifth embodiment of the present invention;

FIG. 24 is an approximate view of the composition of an exposure apparatus provided with an illumination optical device according to a sixth embodiment of the present invention;

FIG. 25 is a flowchart of a procedure for obtaining a semiconductor device as a micro device; and

FIG. 26 is a flowchart of a procedure for obtaining a liquid crystal display element as a micro device.

### DESCRIPTION OF THE PREFERRED EMBODIMENTS

Before describing the preferred embodiments of the present invention, the principle of the present invention will be described.

In an exposure apparatus, as the k1 factor becomes smaller (line width=k1×λ/NA, where λ is the wavelength and NA is the numerical aperture) with increasing fineness of the pattern size, there appear the phenomenon of inaccurate line width resulting from departure of the resolution dimension from the target dimension, the phenomenon of deterioration of fidelity of the resist pattern with respect to the reticle pattern and the phenomenon of marked dependence of the resolution on the type of pattern. For example, there occur the phenomenon of pattern angles which ought to be 90° in the design becoming rounded, the phenomenon of line edges becoming shorter and the phenomenon of line widths becoming wider/narrower. Such phenomena are referred to in general terms as the optical proximity effect (OPE).

Basically “OPE” refers to optical effects during transfer, but, recently, in addition to optical effects, it has come to be used to include resist processing such as exposure dose, type of resist, or resist development time and various effects of for example etching and type of gate material (effects occurring through the entire wafer process (substrate process)). In the present invention, the broad meaning of OPE (effects occurring through the entire wafer process) is employed.

Examples of the causes of such OPE that maybe mentioned include optical effects during exposure (interference of transmitted light between adjacent patterns), resist processing (baking temperature, baking time, development time, type of resist, exposure, and etc.), reflection of the substrate and/or surface irregularity of the substrate and the effects of etching etc. Specifically, there are effects originating in optical factors such as diffraction/interference of light during transfer, pattern dependence on the speed of resist dissolution in resist developing, micro-loading defects during etching of the resist (the phenomenon of lowering of etching speed with decreasing hole aperture or etching width) and the effect of pattern dependence of etching speed etc.

In order to achieve the desired performance of the semiconductor device, it is necessary to achieve the desired dimensions and shape of the design pattern on the wafer. To this end, it has been proposed to correct beforehand on the reticle the corruption of the pattern produced by OPE (deviation of the finished dimensions after etching) (i.e. to apply a correction to the design dimensions on the reticle) Such correction on the reticle is called an optical proximity correction (OPC). As techniques for performing such OPC on the reticle, there are available for example the techniques of adding patterns auxiliary to the main pattern (patterns arranged in positions remote from the main pattern), script patterns (salient (extension) patterns for the purpose of correction added at pattern corners), insection patterns (reentrant patterns for purposes of correction of cutting-off of pattern corners), or hammerhead patterns (hammerhead patterns added to the pattern for correction purposes) and techniques of increasing/decreasing the line width of the main pattern.

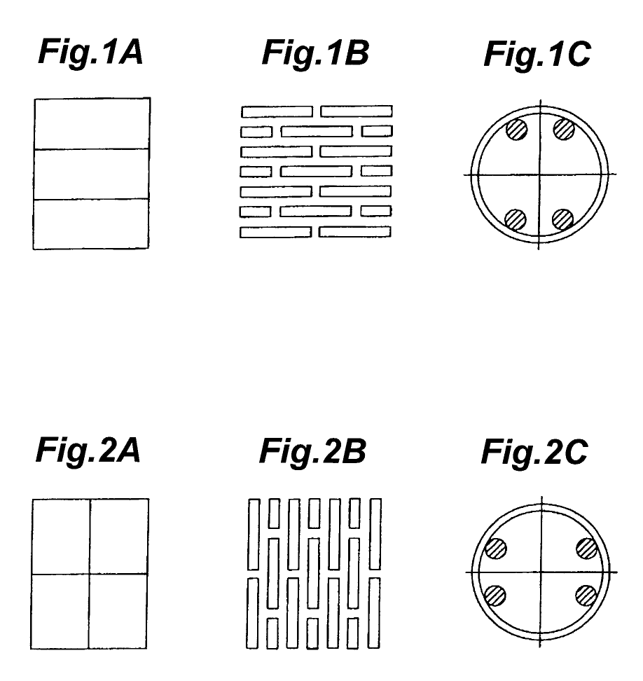

FIGS. 1A to 1C are views for explanation of optimum quadrupole illumination for the manufacture of a triple DRAM chip (in a die). FIGS. 2A to 2C are views for explanation of optimum quadrupole illumination for manufacture of a quadruple DRAM chip (in a die). As shown in FIG. 1A, it is assumed that a triple DRAM chip is manufactured in the field (25 mm×33 mm) of a scanning exposure apparatus. In this case, as shown in FIG. 1B, a memory cell has a minimum pitch in the longitudinal direction and a little longer pitch in the transverse direction.

FIG. 1C shows quadrupole illumination that is optimum for a reticle pattern having a minimum pitch in the longitudinal direction as shown in FIG. 1B. That is, rather than ordinary quadrupole illumination in which four substantially planar light sources are arranged at the vertices of a square formed in the pupil plane (or plane in the vicinity thereof) of the illuminating optical system, quadrupole illumination that is optimum for manufacturing a triple DRAM chip is quadrupole illumination in which four substantially planar light sources are arranged at the vertices of a rectangle that is elongate along the longitudinal direction (direction corresponding optically to the minimum pitch direction of the reticle pattern).

However, for example in the case where a DRAM chip that had been designed with a design rule of 0.25 μm is designed with a design rule of 0.18 μm, the area of each chip is made smaller by so-called “chip shrinking” so that four chips can be obtained with a single exposure where it was hitherto only possible to obtain three. Specifically, as shown in FIG. 2A, a quadruple DRAM chip is manufactured in the field (25 mm×33 mm) of a scanning exposure apparatus. In this case, as shown in FIG. 2B, the memory cells have minimum pitch in the transverse direction and a little longer pitch in the longitudinal direction.

FIG. 2C shows quadrupole illumination that is optimum for a reticle pattern having a minimum pitch in the transverse direction as shown in FIG. 2B. Specifically, instead of the usual quadrupole illumination in which four substantially planar light sources are arranged at the vertices of a square, quadrupole illumination that is optimum for the manufacture of a quadruple DRAM chip consists in quadrupole illumination wherein four substantially planar light sources are arranged at the vertices of a rectangle that is elongate along the transverse direction (direction optically corresponding to the minimum pitch direction of the reticle pattern). In other words, comparing the case where three chips are obtained with the case where four chips are obtained, since the minimum pitch direction of the reticle pattern differs by 90°, the longitudinal direction of the rectangle in which the four substantially planar light sources are arranged is also different by 90°.

It should be noted that, regarding the active pattern (isolation pattern) of memory cells, although the control of line width in the direction in which the pattern pitch is a minimum (longitudinal direction in FIG. 1B) is of course important, since precise contact with the trench nodes and/or stack nodes corresponding to capacitors is important, line width control in the direction orthogonal to the direction of minimum pattern pitch (transverse direction in FIG. 1B) is also important. The “active pattern” here referred to means the pattern of the layer that is arranged nearest the silicon substrate in the DRAM; this layer is called the active layer, isolation layer, element isolating layer or element isolating film etc.

Usually, when creating a reticle (mask), in view of the OPE (optical proximity effect) described above, OPC (optical proximity effect correction) as described above is performed on the reticle. However, in fact, the situation may also arise that it is desirable to perform line width control so as to correct for the OPC, due to the effects of alterations of the resist process and/or aberration of the projection optical system. In such cases, line width correction such as to correct the OPC can be achieved by changing the shape of the rectangle in which the four substantially planar light sources of the quadrupole illumination are arranged. The results of simulation performed in this respect are described below.

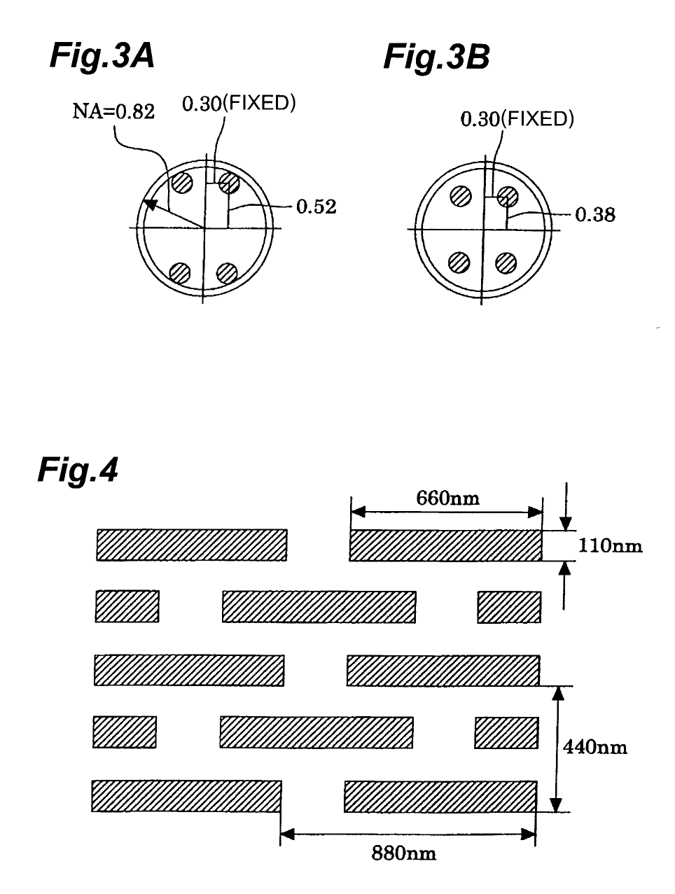

FIGS. 3A and 3B are views for explanation of the mode of quadrupole illumination assumed in the simulation. Also, FIG. 4 is a view for explanation of the layout of the pattern assumed in the simulation. First of all, in the simulation, KrF excimer laser light (wavelength 248 nm) was assumed as the exposure light and a wafer-side numerical aperture NA of the projection optical system of 0.82 was assumed. Also, a maximum value σ of 0.90 of the quadrupole secondary light sources constituting the four planar light sources was assumed, the a value of each circular planar light source being assumed to be 0.15.

Referring to FIG. 3, in terms of NA, taking the position co-ordinate in the longitudinal direction on the pupil plane (or plane in the vicinity thereof) of each circular planar light source formed on the pupil plane of the illumination optical system (or plane in the vicinity thereof) (Y position) as parameter, this was changed from 0.52 to 0.38 with a pitch of 0.02. The position co-ordinate in the transverse direction of each planar light source (X position) is fixed at 0.030. Thus the σ value of the quadrupole secondary light source is a maximum value of 0.90 when the Y position of each planar light source is a maximum value of 0.52. On the other hand, the σ value of the quadrupole secondary light source is a prescribed value somewhat smaller than the maximum value of 0.90 when the Y position of each planar light source has its minimum value of 0.38.

Referring to FIG. 4, the pattern assumed in the simulation is the active pattern of a 110 nm DRAM. In the simulation, a 6% halftone phase-shift reticle is assumed as the reticle. In a halftone phase-shift reticle, a pattern constituted by an upper layer of molybdenum silicon (MoSi) is formed on an under-layer of chromium (Cr) on a glass (silica) substrate. The optical transparency of the pattern region (shaded region in FIG. 4) is set at approximately 6% with respect to the optical transparency of the optically transparent region where the pattern is not formed. Also, the phase of the light passing through the pattern region is set to be inverted with respect to the phase of the light passing through the optically transparent region.

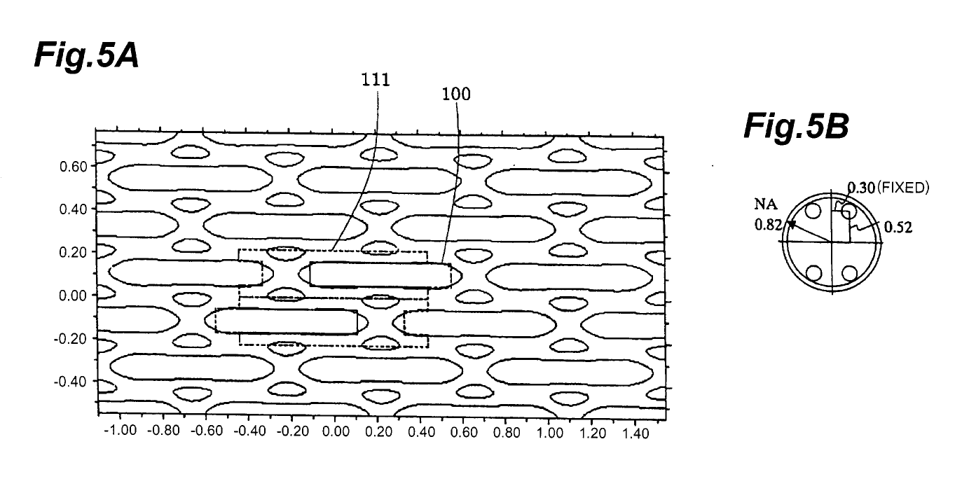

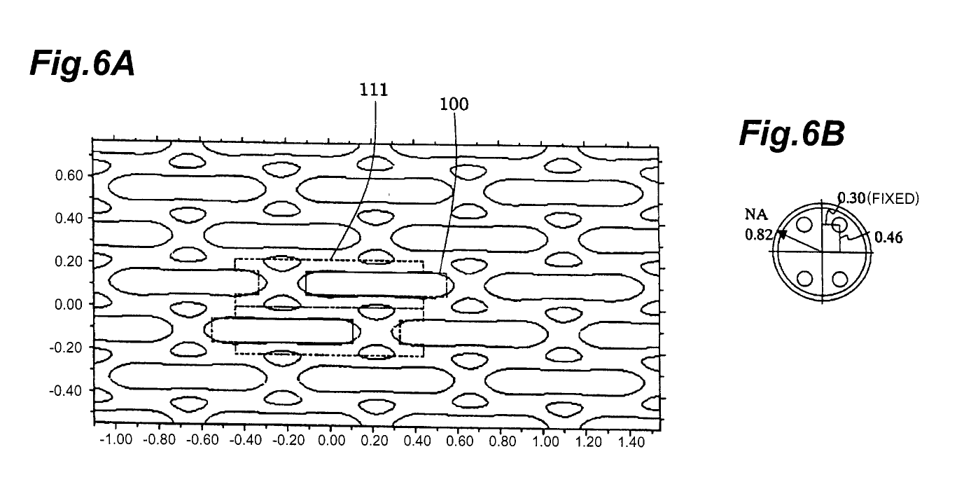

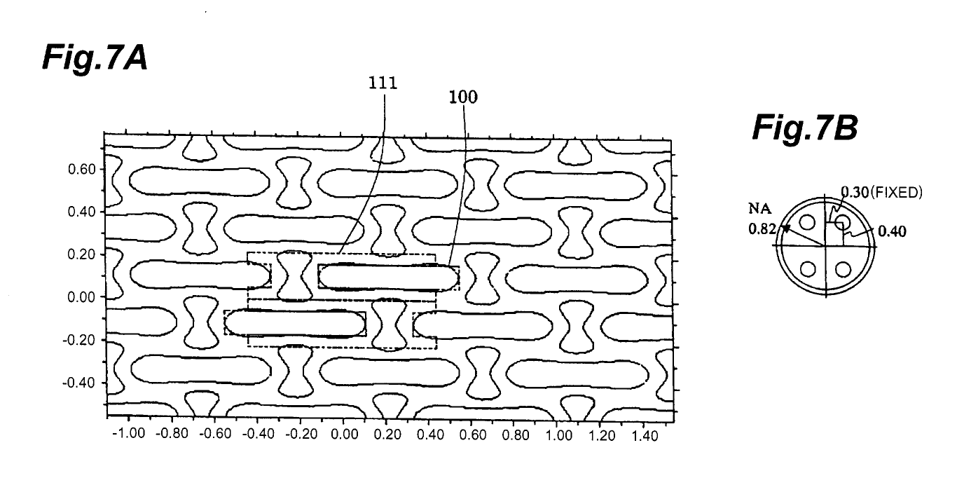

FIG. 5A is a view showing a spatial image of best focus under the illumination condition when Y position of each planar optical source is 0.52 as shown in FIG. 5B. Also, FIG. 6A is a similar view when Y position is 0.46 as shown in FIG. 6B. FIG. 7A is also similar view when Y position is 0.40 as shown in FIG. 7B. FIGS. 5A, 6A and 7A display contours of the intensity of the spatial image under the respective illumination conditions when the slice levels are combined at longitudinal direction 110 nm. Also, the intensity of the region shown in white is twice the intensity of the region shown shaded.

Since in the simulation it is a presupposition that a positive-type resist is employed, the portions of high intensity (i.e. regions other than the shaded regions) are left out of the resist image. In other words, the regions other than the shaded portions in FIGS. 5A, 6A and 7A can be neglected. Also, in FIGS. 5A, 6A and 7A, the rectangular shape shown by the broken line 100 overlapping with the shaded portion indicates the pattern formation position obtained by simply reducing the reticle pattern by the amount of the projection magnification, neglecting aberration or diffraction etc. of the projection optical system i.e. the ideal pattern formation position. Also, the broken line 111 which is overall nearly rectangular indicates the repetition pattern of the region of the overall pattern indicated by this broken line 111.

Referring to FIGS. 5A, 6A and 7A, it can be seen that the size of the spatial image in the transverse direction can be adjusted while maintaining its size in the longitudinal direction constant, by changing the Y position of each planar light source. In other words, it can be seen that the longitudinal/transverse ratio of the spatial image can be adjusted by changing at least one of the positional co-ordinates in the longitudinal direction and the positional co-ordinates in the transverse direction of each planar light source.

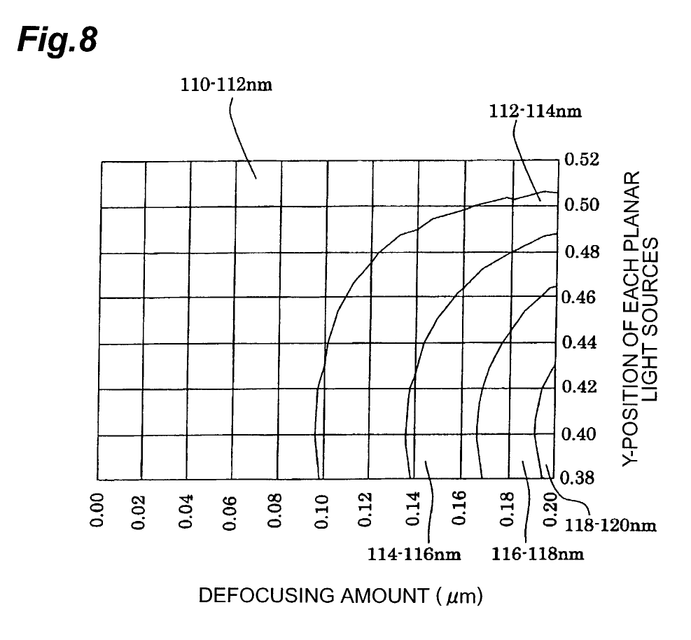

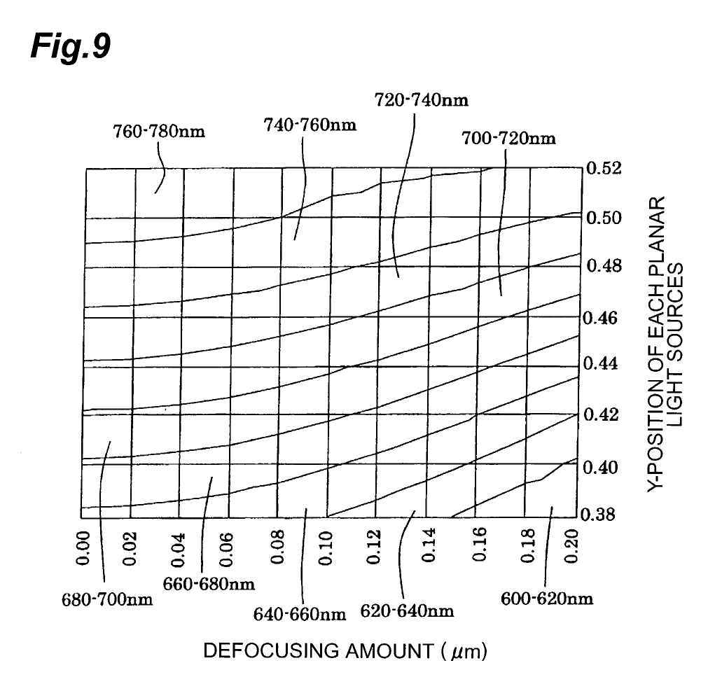

FIGS. 8 and 9 are views showing the line width in the longitudinal and transverse direction of the active pattern under each illumination condition of different Y position of the respective planar light sources and each defocusing condition, respectively. In FIGS. 8 and 9, the vertical axis shows the Y position (in terms of NA=Numerical Aperture) of each planar light source and the horizontal axis shows the amount of defocusing (μm).

In the simulation, the line width in the longitude and transverse direction of the active pattern in each defocusing condition was investigated with the amount of defocusing changed in the range 0.00 μm to 0.20 μm, determining the exposure dose such as to give a line width in the longitudinal direction of 110 nm in the best focus condition, under various illumination conditions with different planar light source Y positions in the range 0.38 to 0.52.

Referring to FIGS. 8 and 9, it can be seen that the line width i.e. the CD (critical dimension) in the transverse direction of the pattern can be controlled over a wide range from 660 nm to 760 nm by changing the Y position of the planar light sources, if the exposure dose is determined such that the line width in the longitudinal direction of the pattern is 110 nm to 120 nm in the entire defocusing range of more 0.0 μm to 0.2 μm. The critical dimension CD is also called the shortest dimension and is typically the value of the dimension indicating line width or separation of patterns of under about 100 μm or pattern position etc. It is used for management of process parameters such as exposure dose, development conditions or etching conditions or product dimension management.

As described above, with the present invention, the resist pattern that is transferred or the substrate pattern (wafer pattern) that is formed by processing (wafer processing) can be produced in a desired size and shape by arranging the four substantially planar light sources at each vertices of a narrow rectangle on the pupil plane or plane in the vicinity thereof. This arrangement realizes that the positional coordinates in the longitudinal direction of these light sources substantially differ the positional coordinates in the transverse direction of those.

Also, if the reticle is provided with a plurality of chip patterns, exposure can be performed in accordance with optimum illumination conditions without dependence on the directionality of the fine pattern on the reticle, by setting at least one of the positional co-ordinates in the longitudinal direction and positional co-ordinates in the transverse direction of four substantially planar light sources such that the positional co-ordinates in the longitudinal direction and the positional co-ordinates in the transverse direction are substantially different, in accordance with the long-side direction of the chip pattern.

Furthermore, at least one of the line width in the longitudinal direction and line width in the transverse direction of the resist pattern or a substrate pattern obtained by means of a reticle that has been subjected to optical proximity effect correction can be adjusted by setting the positional coordinates in the longitudinal direction and positional coordinates in the transverse direction of four substantially planar light sources.

The preferred embodiments of the present invention are described below with reference to the accompanied drawings. To facilitate the comprehension of the explanation, the same reference numerals denote the same parts, where possible, throughout the drawings, and a repeated explanation will be omitted.

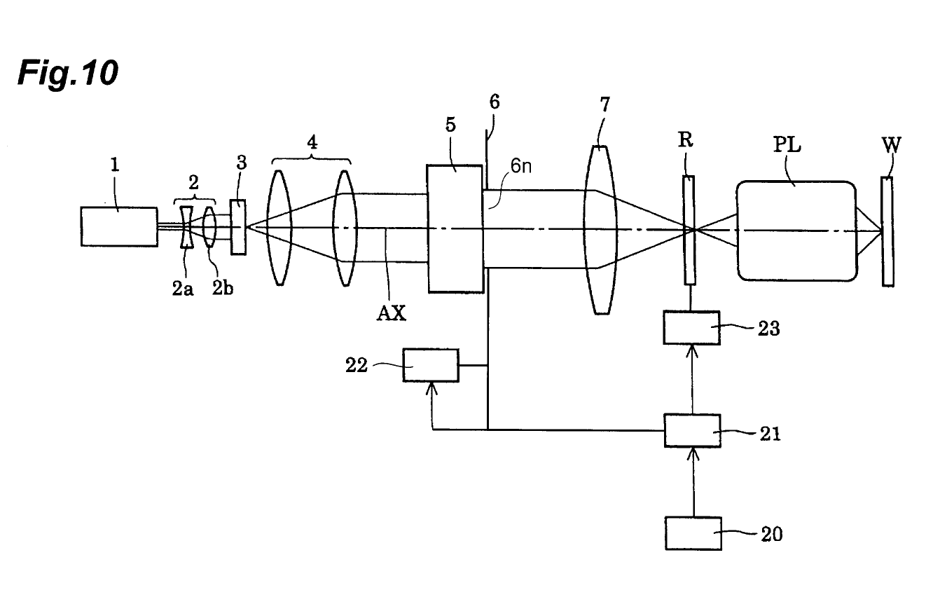

FIG. 10 is a view showing diagrammatically the layout of an exposure apparatus according to a first embodiment of the present invention. The exposure apparatus shown in FIG. 10 comprises a light source (radiation source) 1 for supplying exposure light (illumination light). For example, an excimer laser light source that supplies light of wavelength 248 nm (KrF) or 193 nm (ArF) is suitable as the light source 1. The practically parallel light (radiation) beam emitted from the light source 1 has a rectangular cross-section extending in elongate fashion along the direction perpendicular to the sheet plane of FIG. 10 and is input to a beam expander 2 comprising a pair of lenses 2a and 2b.

The lenses 2a and 2b respectively have negative refracting power and positive refracting power in the sheet plane of FIG. 10 and function as a plane parallel plate in the plane including the optical axis AX orthogonal to this sheet plane. Consequently, the light beam that is input to the beam expander 2 is expanded in this sheet plane and is shaped to the light beam having a cross section of prescribed rectangular shape. The practically parallel light beam that has passed through the shaping optical system constituted by the beam expander 2 is input into a first fly-eye lens 3. The first fly-eye lens 3 is constructed by a dense arrangement of a large number of lens elements having a positive refractive power in the longitudinal and transverse directions. The lens elements constituting the first fly-eye lens 3 may have for example a cross section of square shape.

Consequently, the light beam input into the first fly-eye lens 3 is divided two-dimensionally by a large number of lens elements, thereby forming respective single light sources (converging points) in the focal plane to the rear of each lens element. The light beam from the large number of light sources formed in the focal plane to the rear of the first fly-eye lens 3 illuminates a second fly-eye lens 5 in overlapping manner through a relay lens (relay optical system) 4. The relay lens 4 optically conjugates the focal plane to the rear of the first fly-eye lens 3 and the focal plane to the rear of the second fly-eye lens 5 in practically. In other words, the relay lens 4 couples the focal plane to the rear of first fly-eye lens 3 and the input plane of the second fly-eye lens 5 in a substantially Fourier transform relationship.

The second fly-eye lens 5, like the first fly-eye lens 3, is constituted by a dense longitudinal and transverse arrangement of a large number of lens elements having positive refractive power. However, it should be noted that the lens elements constituting the second fly-eye lens 5 have a rectangular cross-section that is similar to the shape of the illumination field to be formed on the reticle (mask) (and consequently the shape of the exposure region to be formed on the wafer). Consequently, the light beam that is input to the second fly-eye lens 5 is divided two-dimensionally by the large number of lens elements and a large number of light sources are respectively formed in the focal plane to the rear of each of the lens elements to which the light beam is input.

In this way, a substantially planar light source (hereinbelow called a “secondary light source”) of square shape is formed on the focal plane to the rear of the second fly-eye lens 5. The light beam from the secondary light source of square shape that is formed on the focal plane to the rear of the second fly-eye lens 5 is input to an aperture stop 6n arranged in the vicinity thereof. This aperture stop 6n is supported on a turret 6 that is capable of rotation about a prescribed optical axis parallel with the optical axis AX by a first drive system 22.

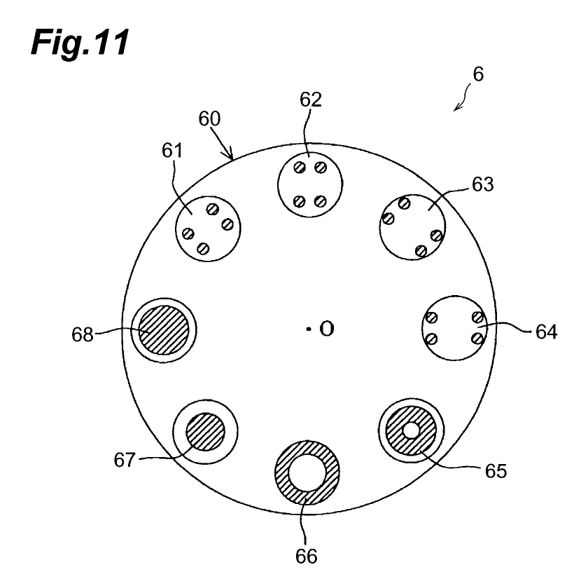

FIG. 11 is a view showing diagrammatically the arrangement of the turret 6 in which a plurality of aperture stops 6n (61 to 68) are arranged in circumferential manner. As shown in FIG. 11, eight aperture stops 61 to 68 having optically transparent regions as shown by the shading in the figure are arranged along the circumferential direction on a turret substrate 60. The turret substrate 60 is constructed to be capable of rotation about an axis parallel with the optical axis AX passing through the centerpoint O thereof. Consequently, by rotating the turret substrate 60, a single aperture stop selected from the eight aperture stops 61 to 68 can be located in position in the illumination optical path. Rotation of the turret substrate 60 is effected by means of the first drive system 22 driven in accordance with instructions from a control system 21.

On the turret substrate 60 there are provided four types of quadrupole aperture stops 61 to 64, two types of annular aperture stops 65 and 66 and two types of circular aperture stops 67 and 68. Each of the quadrupole aperture stops 61 to 64 comprises four off-center circular transparent regions. Also, each of the annular aperture stops 65 and 66 comprises an annular transparent region. Furthermore, each of the circular aperture stops 67 and 68 comprises a circular transparent region.

Consequently, quadrupole illumination can be performed by restricting (regulating) the light beam in quadrupole fashion by positional location of a selected quadrupole aperture stop of the four types of quadrupole aperture stops 61 to 64 in the illumination optical path. Also, annular illumination can be performed by restricting the light beam in annular fashion by positional location of a selected annular aperture stop of the two types of annular aperture stops 65 and 66 in the illumination optical path. Furthermore, circular illumination can be performed by restricting the light beam in circular fashion by positional location of a selected circular aperture stop of the two types of circular aperture stops 67 and 68 in the illumination optical path.

In FIG. 10, a single quadrupole aperture stop 6n selected from the four quadrupole aperture stops 61 to 64 is set as the aperture stop 6. However, the turret construction shown in FIG. 11 is an example only and the type and number of aperture stops that are arranged thereon are not restricted to this. Also, there is no restriction to turret type aperture stops and an aperture stop whose size and shape of the optically transparent region are capable of being suitably altered could be fixedly mounted on the illumination optical path. Furthermore, instead of the two circular aperture stops 67 and 68, an iris diaphragm could be provided whose circular aperture diameter can be continuously varied. And regarding the current system, the number of turrets is not restricted to a single one. For example, in order to increase the number of types of aperture stop that may be selected, a plurality of turrets could be arranged in superimposed manner in the optical axis direction. Also, in order to adjust the a value of the illumination by altering the size of the planar light sources as a whole (in the case where four planar light sources are formed, the diameter of the circle that is externally tangential to these four planar light sources) that are formed on the pupil plane of the illumination optical system, it would be possible to make the relay lens 4 a variable magnification (focal length) optical system (zoom optical system) whose focal length (magnification) can be altered.

After the light beam from the secondary light sources that has passed through the aperture stop 6n, having a quadrupole-shape aperture section (optical transparent section) has been subjected to the beam-condensing action of the condenser optical system 7, it illuminates in overlapping manner reticle R formed with a prescribed pattern. Replacement of the reticle R is effected by means of a second drive system 23 that is actuated in response to instructions from a control system 21. The light beam that has passed through the reticle R performs a reticle pattern image on wafer W which is a photosensitive substrate, through a projection optical system PL. Thus, by performing overall exposure or scanning exposure whilst carrying out secondary drive control of the wafer W in the plane orthogonal to the optical axis AX of the projection optical system PL, the pattern of the reticle R is progressively exposed in the exposure regions of the wafer W.

In the case of batch exposure (overall exposure), the reticle pattern is exposed in batch processing manner (in overall fashion) with respect to each exposure region of the wafer in accordance with the so-called step and repeat system. In this case, the shape of the illumination region on the reticle R is a rectangular shape that is close to a square shape and the cross-sectional shape of the lens elements of the second fly-eye lens 5 is also a rectangular shape that is close to a square shape. In contrast, in the case of scanning exposure, in accordance with the so-called step and scanning system, scanning exposure of the reticle pattern is performed with respect to each exposure region of the wafer, while moving the reticle and the wafer with respect to the projection optical system. In this case, the shape of the illumination regions on the reticle R is for example a rectangular shape of ratio of the short side and long side equal to 1:3 and the cross-sectional shape of the lens elements of the second fly-eye lens 5 is a rectangular shape that is similar thereto.

In the first embodiment, the four types of quadrupole aperture stops 61 to 64 constitute the pupil shape forming unit for forming four substantially planar light sources in the pupil plane (or plane in the vicinity thereof) of the illumination optical system (1 to 7). Information etc. relating to the various types of the reticle that are to be sequentially exposed by the step and repeat system or step and scan system is input to the control system 21 through an input unit 20 such as a keyboard. The control system 21 stores in an internal memory section thereof information such as the optimum line width (degree of resolution) and depth of focus etc. relating to each type of the reticle and supplies suitable control signals to the first drive system 22 and the second drive system 23 in response to the input data from the input unit 20.

Thus, concurrently with replacement of a reticle R by the action of the second drive system 23, the first drive system 22 sets one quadrupole aperture stop of the four quadrupole aperture stops 61 to 64 in position in the illumination optical path in accordance with requirements. When one of the quadrupole aperture stops 61 to 64 is thus set in position in the illumination optical path, the positional co-ordinates in the longitudinal direction and positional co-ordinates in the transverse direction on the pupil plane (or plane in the vicinity thereof) of the four substantially planar light sources are set to be substantially different. In this case, the positional co-ordinates in the longitudinal direction are the co-ordinates of the central position of each planar light source along the vertical direction of the plane of the drawing of FIG. 10. Also, the positional co-ordinates in the transverse direction are the co-ordinates of the central position of each planar light source along the direction perpendicular to the plane of the drawing of FIG. 10.

More specially, when a quadrupole aperture stop 61 or 63 is set in position in the illumination optical path, the positional co-ordinate in the transverse direction is set to be larger than the positional co-ordinate in the longitudinal direction. That is, regarding the ratio of the positional co-ordinates in the longitudinal direction and positional co-ordinates in the transverse direction, taking the positional co-ordinate in the longitudinal direction as being 1, the positional co-ordinate in the transverse direction is at least 1.1. Also, the positional co-ordinate in the transverse direction is set to be larger in the case of the quadrupole aperture stop 63 than in the case of the quadrupole aperture stop 61. Specifically, the quadrupole aperture stops 61 and 63 give a first illumination mode in which four substantially planar light sources are formed such that the ratio of the positional co-ordinate x of the transverse direction with respect to the positional co-ordinate y of the longitude to direction is at least 1.1.

Also, when a quadrupole aperture stop 62 or 64 is set in position in the illumination optical path, the positional co-ordinate in the longitudinal direction is set to be larger than the positional co-ordinate in the transverse direction. Specifically, regarding the ratio of the positional co-ordinate in the longitudinal direction and the positional co-ordinate in the transverse direction, the positional co-ordinate in the longitudinal direction is at least 1.1 if the positional co-ordinate in the transverse direction is taken as 1. Also, the positional co-ordinate in the longitudinal direction is set to be larger in the case of quadrupole aperture stop 64 than in the case of the quadrupole aperture stop 62. That is, the quadrupole aperture stop 62 and 64 provide a second illumination mode in which four substantially planar light sources are formed such that the ratio of the positional co-ordinate x of the transverse direction with respect to the positional co-ordinate y of the longitudinal direction is no more than 1/1.1. As described above, the quadrupole, aperture stops 61 to 64 are set up such that the ratio of the positional co-ordinate in the longitudinal direction and the positional co-ordinate in the transverse direction of the four substantially planar light sources is different in accordance with a ratio of at least 10 percent.

Consequently, in this first embodiment, by setting a selected one quadrupole aperture stop of the four types of quadrupole aperture stops 61 to 64 in position in the illumination optical path and by setting the positional co-ordinate in the longitudinal direction and positional co-ordinate in the transverse direction of the four substantially planar light sources such as to be substantially different, the transferred resist pattern or wafer pattern that is formed by means of the wafer processing can be made of a desired size and shape.

Also, if the reticle R comprises a plurality of chip patterns, by setting at least one of the positional co-ordinate in the longitudinal direction and positional co-ordinate in the transverse direction of the four substantially planar light sources such that the positional co-ordinate or of the longitudinal direction and the positional co-ordinate in the transverse direction are substantially different, in accordance with the direction of the long side of the chip pattern, it is possible to perform exposure with optimum illumination conditions with no dependence on the directionality of the fine pattern on the reticle R. Thus, since there are provided both a first illumination mode in which the ratio of the positional co-ordinate in the transverse direction with respect to the positional co-ordinate in the longitudinal direction of the four substantially planar light sources is at least 1.1 and a second illumination mode in which this ratio is less than 1/1.1, exposure can be performed with optimum illumination conditions without dependence on the directionality of the fine pattern on the reticle R.

Furthermore, by setting the positional co-ordinate in the longitudinal direction and positional co-ordinate in the transverse direction of the four substantially planar light sources, it is possible to adjust at least one of the line width in the longitudinal direction and that in the transverse direction of the resist pattern or wafer pattern obtained through a reticle R that has been subjected to optical proximity effect correction.

Although in the first embodiment described above and the second to the fourth embodiment, to be described follows, an optical path bending mirror (folding mirror) for producing deviation of the optical path of the illumination optical system is omitted, if such an optical path bending mirror is provided, the longitudinal direction and transverse direction of the four substantially planar light sources can be set up taking into account the deviation produced by the optical path bending mirror.

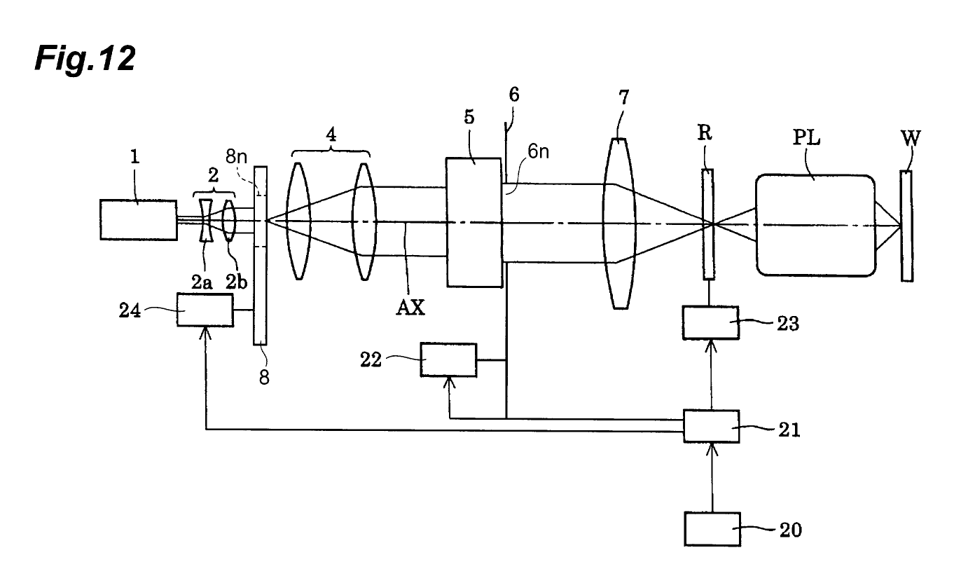

FIG. 12 is a view showing diagrammatically the construction of an exposure apparatus according to a second embodiment of the present invention. The second embodiment is of similar construction to the first embodiment, the fundamental difference being only that a diffractive optical element 8 is provided instead of the first fly-eye lens 3 in the first embodiment. The second embodiment is described below with particular reference to the differences with respect to the first embodiment.

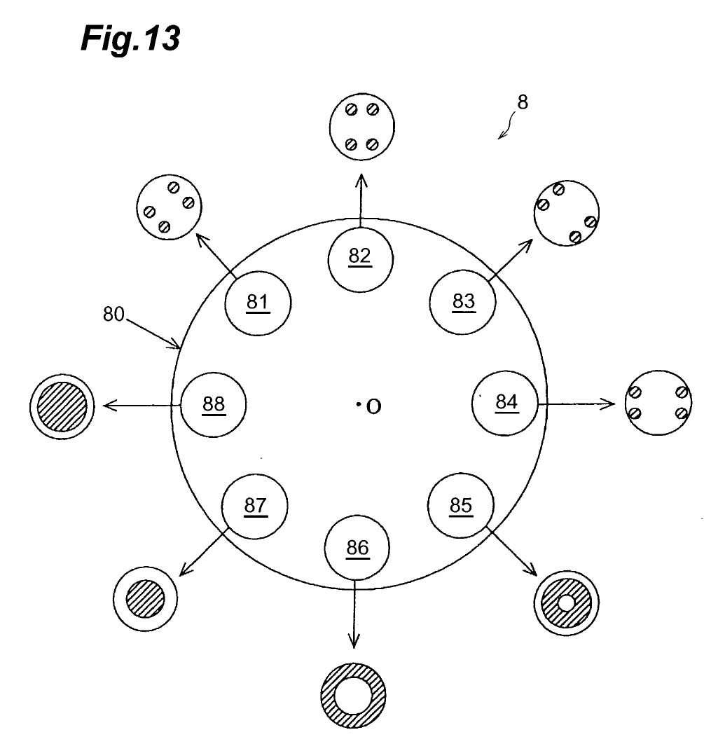

In the second embodiment, the light beam from a light source 1 is input to the diffractive optical element 8n through the beam expander 2. This diffraction element 8n is supported on a turret 8 that is capable of rotation about a prescribed axis parallel with the optical axis AX by a third driven system 24. FIG. 13 is a view showing diagrammatically the construction of a turret 8 in which a plurality of diffractive optical elements 8n (81 to 88) are arranged in a circumferential manner. As shown in FIG. 13, eight diffractive optical elements 81 to 88 are provided along the circumferential direction on a turret substrate 80.

The turret substrate 80 is constructed so as to be capable of rotation about an axis parallel with the optical axis AX passing through its center point O. A selected one diffractive optical element of the eight diffractive optical elements 81 to 88 can thereby be located in position in the illumination optical path by rotating the turret substrate 80. Rotation of the turret substrate 80 is performed by the third drive system 24 that is actuated in response to instructions from the control system 21.

In general, the diffractive optical elements (DOEs) are constituted by forming steps having a pitch of the same order as the wavelength of the exposure light (illuminating light) on a glass substrate (radiation transparent substrate); they have the action of diffracting an incoming beam with a desired angle. Specifically, the diffractive optical elements 81 to 88 form an optical intensity distribution of prescribed shape in the far field (or Fraunhofer diffraction region) i.e. on the incidence face of the second fly-eye lens 5. The turret substrate 80 is provided with four types of quadrupole illumination diffractive optical elements 81 to 84, two types of annular illumination diffractive optical elements 85 and 86 and two types of circular illumination diffractive optical elements 87 and 88. As these diffractive optical elements, for example the diffractive optical elements disclosed in US2002/0080491A or U.S. Pat. No. 5,850,300 may be employed. These US2002/0080491A or U.S. Pat. No. 5,850,300 are incorporated by reference.

As shown in FIG. 13, the diffractive optical elements 81 to 84 have the function of forming on the incidence face of the second fly-eye lens 5 an illumination field of quadrupole shape corresponding to the four off-center circular transparent regions of the aperture stops 61 to 64. Also, the diffractive optical elements 85 and 86 have the function of forming on the incidence face of the second fly-eye lens 5 an illumination field of annular shape corresponding to the annular transmission region of the aperture stops 65 and 66. Furthermore, the diffractive optical elements 87 and 88 have the function of forming on the incidence face of the second fly-eye lens 5 a circular illumination field corresponding to the circular-shaped transmission region of the aperture stops 67 and 68. Hereinbelow, a single diffractive optical element selected from the quadrupole illumination diffractive optical elements 81 to 84 is employed as diffractive optical element 8n.

In this case, the light beam passing through the diffractive optical element 8n forms a quadrupole-shaped illumination field on the incidence face of the second fly-eye lens 5 through the relay lens 4. In this way, a quadrupole-shaped secondary light source having an optical intensity distribution practically the same as that of the illumination field formed by the incident light beam on the second fly-eye lens 5 is formed on the focal plane to the rear of the second fly-eye lens 5. The reticle R is illuminated through the condenser optical system 7 after restriction of the light beam from the quadrupole-shaped-secondary light source formed on the focal plane to the rear of the second fly-eye lens 5 by an aperture stop 6n selected in accordance with the diffractive optical element 8n.

Consequently, in the second embodiment, the four types of quadrupole illumination diffractive optical elements 81 to 84 and quadrupole aperture stops 61 to 64 constitute the pupil shape forming unit for forming four substantially planar light sources on the pupil plane (or plane in the vicinity thereof) of the illumination optical system. Thus, in the second embodiment also, concurrently with replacement of a reticle R, at least one diffractive optical element 8n of the four types of quadrupole illumination diffractive optical elements 81 to 84 is set in position in the illumination optical path and one of the quadrupole aperture stops 6n of the four types of quadrupole aperture stops 61 to 64 is set in position in the illumination optical path, thereby obtaining the same benefits as in the case of the first embodiment.

It should be noted that, in the second embodiment, since an illumination field of prescribed shape is formed on the incidence face of the second fly-eye lens 5 using diffractive optical element 8n, losses of light in the aperture stop 6n can be very well suppressed. Also, in the second embodiment, although the aperture stop 6n is employed as the pupil shape forming unit, the provision of the aperture stop 6n could be omitted by for example employing a micro-lens array instead of the second fly-eye lens 5.

A micro-lens array is an optical element consisting of a large number of micro-lenses having positive or negative refractive power densely arranged longitudinally and transversely. Typically, a micro-lens array is constituted by forming a group of micro-lenses by carrying out etching treatment on for example a plane parallel glass plate. In this case, the micro-lenses constituting the micro-lens array are smaller than the lens elements constituting the fly-eye lens. Also, in the micro-lens array, unlike the fly-eye lens constituted of mutually separated lens elements, a large number of micro-lenses are integrally formed without mutual separation. However, a micro-lens array is the same as a fly-eye lens in that it comprises lens elements having positive or negative refractive power arranged in longitudinal and transverse fashion.

In the first embodiment described above also, a micro-lens array could be employed instead of at least one of the first fly-eye lens 3 and the second fly-eye lens 5. Also, when provision of an aperture stop 6n as described above is dispensed with, a first illumination mode is produced in which quadrupole illumination diffractive optical elements 81 and 83 form four substantially planar light sources with the ratio of positional co-ordinate x in the transverse direction with respect to positional co-ordinate y in the longitudinal direction at least 1.1 on the pupil plane of the illumination optical system and a second illumination mode is produced in which quadrupole illumination diffractive optical elements 82 and 84 form four substantially planar light sources with the ratio of positional co-ordinate x in the transverse direction with respect to positional co-ordinate y in the longitudinal direction less than 1/1.1 on the pupil plane of the illumination optical system.

Also, in the second embodiment, the number of the turret substrates 80 is not restricted to one. For example, in order to increase the types of diffractive optical element that may be selected, a plurality of turrets 8 could be arranged in superimposed manner in the optical axis direction. Also, in order to adjust the a value of the illumination by altering the size of the planar light sources as a whole (in the case where four planar light sources are formed, the diameter of the circle that is externally tangential to these four planar light sources) that are formed on the pupil plane of the illumination optical system, it would be possible to make the relay lens 4 a variable magnification (focal length) optical system (zoom optical system) whose focal length (magnification) can be altered.

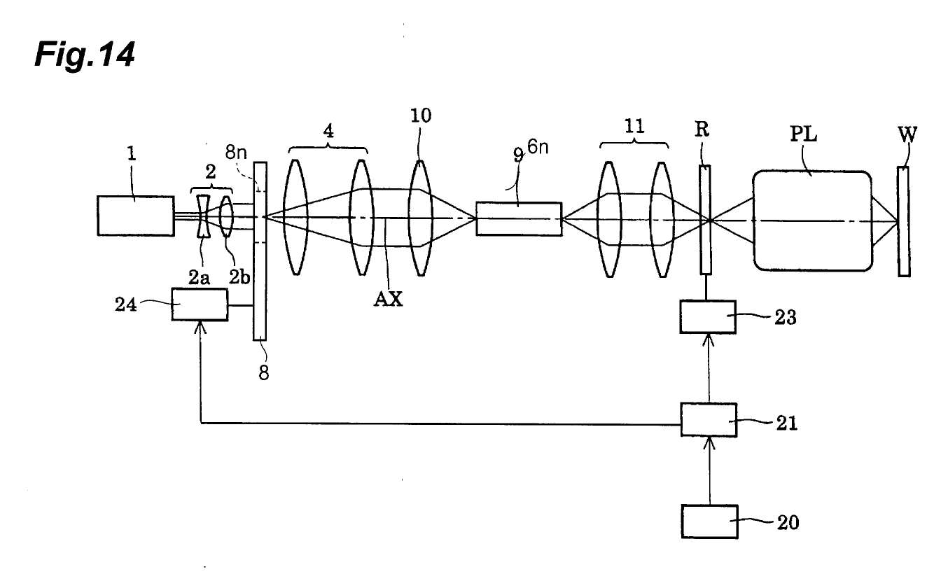

FIG. 14 is a view showing diagrammatically the construction of an exposure apparatus according to a third embodiment of the present invention. The third embodiment is of similar construction to the second embodiment, the fundamental difference is that an internal face reflective type rod type optical integrator 9 is provided instead of the wave surface division type fly-eye lens 5 in the second embodiment and omitted the aperture stop 6n. The third embodiment is described below with particular reference to the differences with respect to the second embodiment.

In the third embodiment, corresponding to the use of a rod type integrator 9 instead of the second fly-eye lens 5, a condenser lens 10 is added in the optical path between the relay lens 4 and the rod type integrator 9 and an imaging optical system 11 is provided instead of the condenser optical system 10 and the aperture diaphragm for restricting secondary light sources is removed. The combined optical system comprising the relay lens 4 and the condenser lens 10 couples in practically optically conjugated manner the input faces of the diffractive optical element 8 and the rod type integrator 9. Also, the imaging optical system 11 couples in practically optically conjugated manner the emission face of the rod type integrator 9 and the reticle R.

The rod type integrator 9 is an internal face reflecting type of glass rod made of a glass material such as silica or fluorite, and forms light source images of a number corresponding to the number of internal face reflections along the plane parallel to the rod input plane passing through the focal point, by utilizing total reflection at the boundary surface between the interior and exterior i.e. at the inside surface. Practically all of the light source images that are thus formed are virtual images but the light source image in the center (focal point) only is a real image. Specifically, the light beam that is input to the rod type integrator 9 is divided in the angular direction by reflection at the inside face, forming the secondary light sources comprising a large number of light source images along a plane parallel with the input plane thereof and passing through the focal point.

The light beam from the secondary light sources formed on the input side thereof by the rod type integrator 9 is superimposed at the emission face thereof and uniformly illuminates the reticle R formed with a prescribed pattern through the imaging optical system 11. As mentioned above, the imaging optical system 11 provides practically conjugate optical coupling of the emission face of the rod type integrator 9 and the reticle R (and consequently wafer W). A rectangular illumination field similar to the cross-sectional shape of the rod type integrator 9 is therefore formed on the reticle R.

As described above, in the third embodiment, an aperture stop 6n for restricting the secondary light sources can be omitted. Also, concurrently with replacement of a reticle R, at least one diffractive optical element of the four types of quadrupole illumination diffractive optical elements 81 to 84 is set in position in the illumination optical path and one of the quadrupole aperture stops 6n of the four types of quadrupole aperture stops 61 to 64 may be set in position in the illumination optical path, thereby obtaining the same benefits as in the case of the second embodiment.

In the third embodiment also, as in the second embodiment, the number of the turret substrates 80 is not restricted to a single one and a plurality of the turret substrates 80 could be arranged in superimposed manner in the optical axis direction. Also, in order to adjust the σ value of the illumination by altering the size of the planar light sources as a whole (in the case where four planar light sources are formed, the diameter of the circle that is externally tangential to these four planar light sources) that are formed on the pupil plane of the illumination optical system, it would be possible to make at least one of the relay lens 4 and the condenser lens 10 a variable magnification (focal length) optical system (zoom optical system) whose focal length (magnification) can be altered.

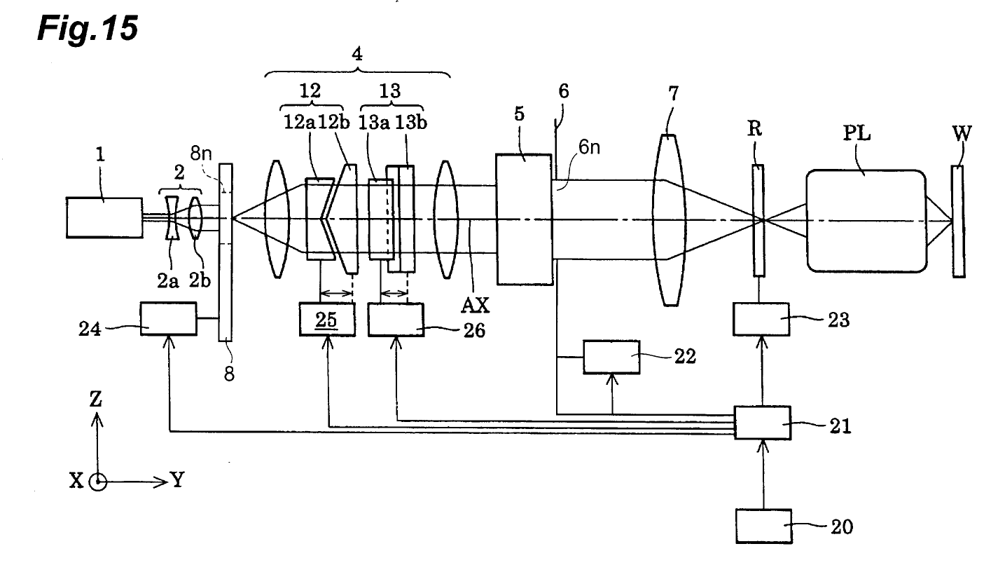

FIG. 15 is a view showing diagrammatically the construction of an exposure apparatus according to a fourth embodiment of the present invention. The fourth embodiment is of similar construction to the second embodiment, the fundamental difference being only that a first V groove axicon system (a first V-shaped axicon system) 12 and a second V groove axicon system (a second V-shaped axicon system) 13 are arranged in order from the light source side on the optical path of the relay lens 4 in the second embodiment. The fourth embodiment is described below with particular reference to the differences with respect to the second embodiment.

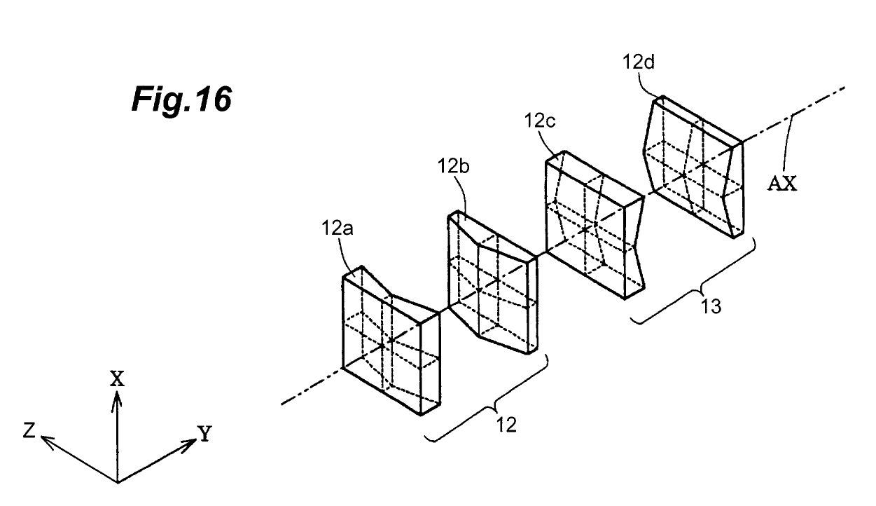

As shown in FIGS. 15 and 16, the first V groove axicon system 12 comprises, in order from the light source side, a first prism 12a with a plane face thereof directed to the light source side and a concave-shaped refractive face thereof directed to the reticle side and a second prism 12b with a plane face thereof directed to the reticle side and a convex refractive face thereof directed to the light source side. The concave-shaped refractive face of the first prism 12a comprises two planes that are parallel with the X direction and has a V-shaped convex-shaped cross-section in the YZ plane.

The convex-shaped refractive face of the second prism 12b is formed so as to be capable of mutual abutment with the concave-shaped refractive face of the first prism 12a, in other words, is formed in complementary fashion to the concave-shaped refractive face of the first prism 12a. That is, the concave-shaped refractive face of the second prism 12b is constituted of two planes parallel with the X direction and has a V-shaped concave-shaped cross section in the YZ plane. Also, at least one of the first prism 12a and the second prism 12b is constituted to be capable of movement along the optical axis AX, so that the distance therebetween is variable. The distance variation of the first V groove axicon system 12 is effected by a fourth drive system 25 that is actuated in response to instructions from the control system 21.

The second V groove axicon system 13 comprises, in order from the light source side, a first prism 13a with a plane face thereof directed to the light source side and a concave-shaped refractive face thereof directed to the reticle side and a second prism 13b with a plane face thereof directed to the reticle side and a convex refractive face thereof directed to the light source side. The concave-shaped refractive face of the first prism 13a comprises two planes that are parallel with the Z direction and has a V-shaped convex-shaped cross-section in the XY plane. The convex-shaped refractive face of the second prism 13b is formed so as to be capable of mutual abutment with the concave-shaped refractive face of the first prism 13a, in other words, is formed in complementary fashion to the concave-shaped refractive face of the first prism 13a.

That is, the concave-shaped refractive face of the second prism 13b is constituted of two planes parallel with the Z direction and has a V-shaped concave-shaped cross section in the XY plane. Also, at least one of the first prism 13a and the second prism 13b is constituted to be capable of movement along the optical axis AX, so that the distance therebetween is variable. As described above, the second V groove axicon system 13 has a configuration obtained by 90° rotation about the optical axis AX of the first V groove axicon system 12. The distance variation of the second V groove axicon system 13 is effected by a fifth drive system 26 that is actuated in response to instructions from the control system 21.

In a condition in which the concave-shaped refractive face of the first prism 12a and the convex-shaped refractive face of the second prism 12b are in mutual abutment, the first V groove axicon system 12 functions as a plane parallel plate and has no effect on the quadrupole secondary light sources formed in the focal plane on the rear side of the second fly-eye lens 5. However, when the concave-shaped refractive face of the first prism 12a and the convex-shaped refractive face of the second prism 12b are separated, the first V groove axicon system 12 functions as a parallel planar plate along the X direction and functions as a beam expander along the Z direction. Consequently, by the action of the first V groove axicon system 12, only the positional co-ordinates in the longitudinal direction of the four planar light sources are changed, without changing their positional co-ordinates in the transverse direction.

Also, in a condition in which the concave-shaped refractive face of the first prism 13a and the convex-shaped refractive face of the second prism 13b are in mutual abutment, the second V groove axicon system 13 functions as a plane parallel plate and has no effect on the quadrupole secondary light sources formed in the focal plane on the rear side of the second fly-eye lens 5. However, when the concave-shaped refractive face of the first prism 13a and the convex-shaped refractive face of the second prism 13b are separated, the second V groove axicon system 13 functions as a parallel planar plate along the Z direction and functions as a beam expander along the X direction. Consequently, by the action of the second V groove axicon system 13, only the positional co-ordinates in the transverse direction of the four planar light sources are changed, without changing their positional co-ordinates in the longitudinal direction.

As described above, with this embodiment, although four types of quadrupole illumination diffractive optical elements 81 to 84 are provided, by the action of the first V groove axicon system 12 and the second V groove axicon system 13, the positional co-ordinates in the longitudinal direction and the positional co-ordinates in the transverse direction of the four planar light sources can be respectively continuously changed and set to desired values.

In this embodiment also, it is desirable that the ratio of the positional co-ordinate in the longitudinal direction and the positional co-ordinate in the transverse direction of the four substantially planar light sources should be set so as to differ in accordance with a ratio of at least 10% i.e. that the ratio of the positional co-ordinate x in the transverse direction with respect to the positional co-ordinate y in the longitudinal direction of the four substantially planar light sources should be set to at least 1.1, or that this ratio should be set to less than 1/1.1.

In this embodiment also, just as in the case of the second embodiment, the number of the turret substrates 80 is not restricted to a single one and a plurality of the turret substrates 80 could be arranged in superimposed manner in the optical axis direction. Also, in order to adjust the σ value of the illumination by altering the size of the planar light sources as a whole (in the case where four planar light sources are formed, the diameter of the circle that is externally tangential to these four planar light sources) that are formed on the pupil plane of the illumination optical system, it would be possible to make the relay lens 4 a zoom lens.

Furthermore, it should be noted that, while, in the this embodiment, the first V groove axicon system 12 and the second V groove axicon system 13 were arranged in the optical path of the relay lens 4, in addition to this, it would also be possible to additionally provide a so-called conical axicon system therein. Alternatively, a conical axicon system could be provided instead of the first V groove axicon system 12 or the second V groove axicon system 13. A conical axicon system is an axicon system comprising a first prism having a conical convex-shaped refractive face and a second prism having a conical concave-shaped refractive face. It is preferable that a distance between the first prism with the conical convex-shaped axicon and the second prism with the conical concave-shaped axicon are adjustable.

In the embodiments described above, if the ratio of the number of respective apertures of the four light beams from the four substantially planar light sources with respect to the number of reticle-side apertures of the projection optical system is taken as σs, it is desirable that

0.1≦σs≦0.3

should be satisfied.

Below the above lower limit, fidelity of the image decreases and above the upper limit there is little benefit in terms of magnifying the depth of focus; these situations are therefore undesirable.

Also, in the embodiment described above, the four planar light sources were formed on the pupil plane of the illumination optical system or a plane in the vicinity thereof but, it is preferable that the position of the barycenter of a single planar light source of these four substantially planar light sources should satisfy following condition.

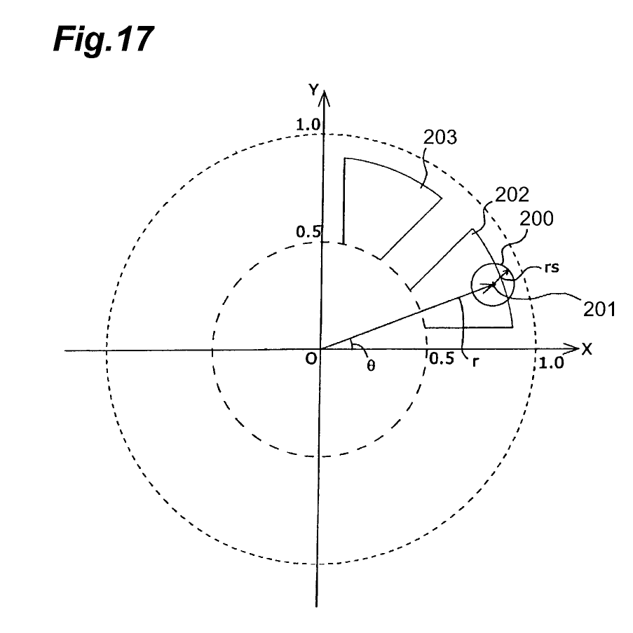

This preferable condition is described in detail below with reference to FIG. 16, which is a diagram of the four substantially planar light sources formed on the pupil of the illumination optical system. FIG. 17 illustrates a single planar light source 200 that is positioned in a first quadrant of the four substantially planar light sources in the XY co-ordinate system whose origin 0 is the optical axis of the illumination optical system. In FIG. 17 polar co-ordinates are setup whose pole is the optical axis (origin O) of the illumination optical system and the co-ordinates of the position 201 of the barycenter of this planar light source 200 are denoted by (r, θ). FIG. 17 is normalized by taking the radius of the pupil of the projection optical system as 1. In FIG. 17, the radius of the image of the pupil of the projection optical system formed by the optical system located from the pupil of the projection optical system to the pupil of the illumination optical system is 1.

In FIG. 17, r is the radius when the position 201 of the barycenter is expressed in polar co-ordinates (distance from point O to position 201 of the barycenter) and θ is the anger of deviation (angle made by the x axis and the radius) when the position 201 of the barycenter is expressed in polar co-ordinates. Also, rs is the distance from the position 201 of the barycenter on the planar light source 200 to the outermost circumferential edge. Although the shape of the planar light source 200 in FIG. 16 is circular, the shape of the planar light source 200 is not restricted to being circular but could be for example a quadrilateral shape, hexagonal shape or sector shape etc. If the shape of the planar light source 200 is circular, rs is the radius of the planar light source 200 but if it is not circular then rs is the shortest distance of the distances from the position 201 of the barycenter in the planar light source 200 to the outermost circumferential edge.

As shown in FIG. 17, in the first illumination mode, the position 201 of the barycenter of the planar light source 60 is located in a region 202 expressed by:

0.5≦r<1−rs and

sin⁻¹{(rs)/(1−rs)}<θ<Π/4

And in the second illumination mode the position 201 of the barycenter of the planar light source 200 is located in a region 203 expressed by:

0.5<r<1−rs and

Π/4<θ<Π/2−sin⁻¹{(rs)/(1−rs)}.

As described above, exposure can be effected in accordance with optimum exposure conditions irrespective of the directionality of the fine pattern on the reticle R, by setting the first and second illumination modes. The position of a specific one planar light source of the four planar light sources was described in FIG. 16 but the four substantially planar light sources in each embodiment are arranged in a second order rotationally symmetric manner about the optical axis of the illumination optical system as center on the pupil plane or plane in the vicinity thereof, where n-th order rotational symmetry means that when an arbitrary spatial pattern is rotated by an angle of 1/(integer n) of a full rotation about an arbitrary spatial axis, a pattern identical with the original pattern is displayed.

Thus, preferably, when the four substantially planar light sources are arranged with the second order rotational symmetry about the optical axis of the illumination optical system, in the first illumination mode, the first planar light source of the four planar light sources that is positioned in the first quadrant satisfies:

0.5<r<1−rs and

sin⁻¹{(rs)/(1−rs)}<θ<Π/4

the second planar light source of the four planar light sources that is positioned in the second quadrant satisfies:

0.5<r<1−rs and

3Π/4<θ<Π−sin⁻¹{(rs)/(1−rs)}

the third planar light source of the four planar light sources that is positioned in the third quadrant satisfies:

0.5<r<1−rs and

Π+sin⁻¹{(rs)/(1−rs)}<θ<5Π/4 and

the fourth planar light source of the four planar light sources that is positioned in the fourth quadrant satisfies:

0.5<r<1−rs and

7 Π/4<θ<2Π−sin⁻¹{(rs)/(1−rs)}

And, in this case, in the second illumination mode, preferably the first planar light source of the four planar light sources that is positioned in the first quadrant satisfies:

0.5<r<1−rs and

Π/4<θ<(Π/2)−sin⁻¹{(rs)/(1−rs)}

the second planar light source of the four planar light sources that is positioned in the second quadrant satisfies:

0.5<r<1−rs and

(Π/2)+sin⁻¹{(rs)/(1−rs)}<θ<3Π/4

the third planar light source of the four planar light sources that is positioned in the third quadrant satisfies:

0.5<r<1−rs and

5Π/4<θ<(3Π/2)−sin⁻¹{(rs)/(1−rs)}

and the fourth planar light source of the four planar light sources that is positioned in the fourth quadrant satisfies:

0.5<r<1−rs and

(3Π/2)+sin⁻¹{(rs)/(1−rs)}<θ<7Π/4.

By setting the first and second illumination modes in this way, exposure can be performed in accordance with the optimum exposure conditions without dependence on the directionality of the fine pattern on the reticle R. Also, in the first, second and fourth embodiment described above, a relay optical system that projects onto the reticle R an image of a uniform illumination plane formed by the condenser optical system 7 may be arranged in the optical path between the reticle R and the condenser optical system 7 that condensates the light from the secondary optical system formed by the second fly-eye lens 5. In this case, a reticle blind (illumination field of view diaphragm) is preferably arranged in a position that is made conjugate with the reticle R by this relay optical system.

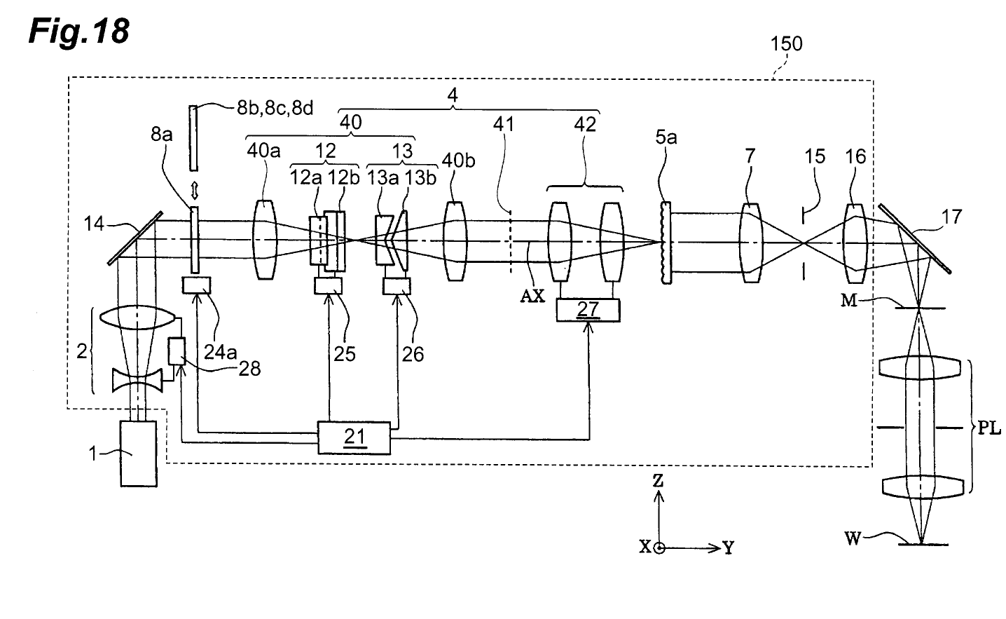

FIG. 18 is an approximate view of the structure of an exposure apparatus as a fifth embodiment of the present invention. The exposure apparatus in FIG. 17 comprises a KrF or an ArF excimer laser light source as a light source 1. Substantially parallel light beam emitted from the light source 1 is input to a beam expander 2 constituted by a pair of lenses 2a and 2b as other embodiments.

The substantially parallel light beam passed through the beam expander forming a reshaping optical system is then deflected in the Y direction by a deflecting mirror 14, and input to a diffractive optical element (DOE) 8n (8a, 8b 8c or 8d) for quadrupolar illumination. In general, the diffractive optical element 8n is constituted by forming a glass substrate with a step difference of equivalent pitch to the wavelength of the exposure light (illumination light), which imparts an action of diffracting the incident beam by a prescribed angle. More specifically, the diffractive optical element 8a for quadrupolar illumination has a function for forming a quadrupolar light intensity distribution in the far field (Fraunhofer diffraction region), when parallel light beam having a rectangular cross-section is input thereto. In this way, the diffractive optical element 8a constitutes a light beam converting element for converting the light beam from the light source 1 into quadrupolar light beam.

The diffractive optical element 8a is constituted insertably and removably with respect to the illumination optical path, in such a manner that it can be switched to a diffractive optical element 8b for annular illumination, a diffractive optical element 8c for circular illumination, or a diffractive optical element 8d for adjustment. Here, the switching between the diffractive optical element 8a for quadrupolar illumination, the diffractive optical element 8b for annular illumination, the diffractive optical element 8c for circular illumination, and the diffractive optical element 8d for adjustment is performed by means of a third drive system 24a which operates on the basis of commands from a control system 21.

The light beam passed through the diffractive optical element 8a forming a light beam converting element is input to a relay lens system 4. This relay lens system comprises of an afocal lens (system) 40 and a zoom lens (system) 42. The afocal lens 40 is an afocal system (optical system having an infinite focal length) which is set in such a manner that the front side focal point substantially coincides with the position of the diffractive optical element 8a, and the rear side focal point substantially coincides with the position of the designated plane 41 indicated by the broken line in the diagram. Therefore, once the substantially parallel light beam input to the diffractive optical element 8a has been formed into a quadrupolar light intensity distribution on the face of the afocal lens 40, it is then formed into parallel light beam and output from the afocal lens 40.

A first V-grooved axicon system 12 and a second V-grooved axicon system 13 are disposed, in sequence from the light source side, in the optical path between the front lens group 40a of the afocal lens 40 and the rear lens group 40b thereof. Below, in order to simplify the description, the action of these axicon systems 12 and 13 is ignored, and the basic composition and action of the fifth embodiment is described.

The light beam transmitted by the afocal lens 40 passes through the designated plane 41, whereupon it is input to a micro lens array 5a forming a wavefront dividing type optical integrator, via a zoom lens (variable magnification optical system) 42 of variable σ value having a 3-group structure, for example. The micro lens array 5a is an optical element consisting of a plurality of miniature lenses having positive or negative refractive power disposed in a dense vertical and horizontal configuration. In general, a micro lens array is constituted by forming a group of miniature lenses by etching a flat, parallel glass substrate (parallel radiation transparent substrate), for instance.

Here, the respective miniature lenses forming the micro lens array are smaller than the lens elements constituting the fly-eye lens. Moreover, unlike the fly-eye lens, which consists of mutually separated lens elements, the micro lens array is formed as a single member, without mutual separation between the plurality of miniature lenses. However, the micro lens array is similar to the fly-eye lens in that it comprises lens elements having positive or negative refractive power arranged in a vertical and horizontal configuration. In FIG. 17, in order to simplify the diagram, the number of miniature lenses forming the micro lens array 5a is shown to be many fewer than is the case in reality.

The position of the designated plane 41 is located in the vicinity of the front side focal position of the zoom lens 42, and the input face of the micro lens array Sa is disposed in the vicinity of the rear side focal position of the zoom lens 42. In other words, the zoom lens 42 is disposed effectively in a Fourier transform relationship with respect to the prescribed face 41 and the input face of the micro lens array 5a, and consequently, it is disposed substantially in optical conjugation with respect to the lens face of the afocal lens 40 and the input face of the micro lens array 5a. The focal length of the zoom lens 42 is changed by means of a sixth drive system 27 which operates on the basis of commands from the command system 21.

A quadrupolar illumination field consisting of four illumination fields which are displaced symmetrically with respect to the optical axis AX, for example, is formed on the input face of the micro lens array 5a, similarly to the afocal lens 40. The shape of the respective illumination fields constituting the quadrupolar illumination filed are dependent on the characteristics of the diffractive optical element 4a, but here, it is assumed that a quadrupolar illumination field is formed by four circular illumination fields. The overall shape of the quadripolar illumination field is dependent on the focal length of the zoom lens 42 and can be changed in a homothetic manner.

The respective miniature lenses forming the micro lens array 5a have a rectangular cross-section which resembles the shape of the illumination field that is to be formed on the mask M (and consequently, the shape of the exposure region to be formed on the wafer W). The light beam incident on the micro lens array 5a is divided two-dimensionally by the plurality of miniature lenses, whereupon, at the rear side focal plane (in other words, their is of the illumination optical system), a secondary light source having substantially the same light intensity distribution as the illumination field formed by the incident light beam on the micro lens array 5a, in other words, a quadrupolar secondary light source consisting of four circular, substantially planar light sources displaced symmetrically with respect to the optical axis AX, is created.

The light beam from the quadrupolar secondary light source formed on the rear side focal plane of the micro lens array 5a receives a focusing action by the condenser optics 7, and then illuminates a mask blind 15 forming a illumination field aperture, in an overlapping manner. The light beam passed by the rectangular opening (light transmitting section) of the mask blind 15 then receives a focusing action from the image formation optical system 16, whereupon it is irradiated in an overlapping manner onto the mask M. The light beam transmitted by the mask M pattern forms a mask pattern image on the wafer W forming the photosensitive substrate, via a projection optical system PL. In this way, by performing universal exposure (batch exposure) or scanning exposure whilst driving and controlling the wafer W in a two-dimensional manner within a plane (XY plane) orthogonal to the optical axis AX of the projection optical system PL, the pattern of the mask M is successively exposed onto respective exposure regions of the wafer W.

In universal exposure (batch exposure), the mask pattern is exposed universally (batchwise) with respect to each exposure region of the wafer, in accordance with a so-called “step and repeat” method. In this case, the shape of the illumination region of the mask M is a rectangular shape which approximates a square shape, and the sectional shape of the respective miniature lenses of the micro lens array 5a is also a rectangular shape which approximates a square shape. On the other hand, in scanning exposure, the mask pattern is exposed by scanning with respect to each exposure region of the wafer, whilst moving the mask and wafer relatively with respect to the projection optical system, according to a so-called “step and scan method”. In this case, the shape of the illumination region of the mask M is a rectangular shape which a short edge to long edge ratio of 1:3, for example, and the sectional shape of the respective miniature lenses of the micro lens array 5a is a similar rectangular shape.

As described above in the explanation of the fourth embodiment, if the concave refracting face and the convex refracting face in the first V-grooved axicon system 12 are separated, then although the system will function as a parallel planar member in the Z direction, it will function as a beam expander in the X direction. Moreover, if the concave refracting face and the convex refracting face in the first V-grooved axicon system 13 are separated, then although the system will function as a parallel planar member in the X direction, it will function as a beam expander in the Z direction.

Consequently, when the interval in the first V-grooved axicon system 12 changes, although the angle of incidence of the light beam on the designated plane 41 does not change in the Z direction, the angle of incidence of the light beam on the designated plane 41 does change in the X direction. As a result, the four circular planar light sources constituting the secondary light source formed on the rear side focal plane of the micro lens array 5a do not move in the Z direction, but they do move in the X direction, whilst maintaining the same shape and size. On the other hand, when the interval in the second V-grooved axicon system 13 changes, although the angle of incidence of the light beam on the designated plane 41 does not change in the X direction, the angle of incidence of the light beam on the designated plane 41 does change in the Z direction. As a result, the four circular planar light sources do not move in the X direction, but they do move in the Z direction, whilst maintaining the same shape and size.

Furthermore, if both the interval in the first and the second V-grooved axicon systems 12 and 13 are changed, then the angle of incidence of the light beam on the designated plane 41 changes in both the X direction and the Z direction. Consequently, the four circular planar light sources moves in the Z direction and the X direction, whilst maintaining the same shape and size. As stated previously, when the focal length of the zoom lens 42 is changed, the four circular planar light sources change in size, in a homothetic manner, whilst maintaining the same shape and centre position.

Moreover, as described above, the diffractive optical element 8a is constituted detachably and insertably with respect to the illumination optical path, in such a manner that it may be switched for a diffractive optical element 8b for annular illumination, a diffractive optical element 8c for circular illumination, or a diffractive optical element 8d for adjustment. Below, a brief description is given of annular illumination obtained when the diffractive optical element 8b is set in the illumination optical path, instead of the diffractive optical element 8a.

If the diffractive optical element 8b is set in the illumination path instead of the quadripolar diffractive optical element 8a, the light beam transmitted by the diffractive optical element 8b is input to the afocal lens 40 and forms an annular light intensity distribution on the iris face thereof. The light from the annular light intensity distribution is substantially parallel and is output from the afocal lens 40, via a zoom lens 42, and forms an annular illumination field centered on the optical axis AX, on the incident face of the micro lens array 5a. Consequently, a secondary light source having substantially the same light intensity as the illumination field formed on the incident face, in other words, an annular secondary light source centered on the optical axis, AX, is formed on the rear side focal plane of the micro lens array 5a. In this case, if the focal length of the zoom lens 42 is changed, then the whole annular secondary light source is either enlarged or reduced, in a homothetic manner.

Next, circular illumination as obtained by setting the diffractive optical element 8c for circular illumination in the illumination optical path instead of the diffractive optical element 8a or 8b, will be described. The diffractive optical element 8c for circular illumination has a function of converting incident rectangular light beam into circular light beam. Consequently, the circular light beam formed via the diffractive optical element 8c is input to the afocal lens 40, and a circular light intensity distribution is formed on the iris face thereof. The light from this circular light intensity distribution forms substantially parallel light beam and is output from the afocal lens 40 via the zoom lens 42 to the incident face of the micro lens array 5a, where it forms a circular illumination field centered on the optical axis AX. As a result, a secondary light source having substantially the same light intensity as the illumination field formed on the input side of the micro lens array 5a, in other words, a secondary light source centered on the optical axis AX, is created at the rear side focal plane of the micro lens array 5a. In this case, when the focal length of the zoom lens 42 is changed, the overall circular secondary light source is also enlarged or reduced, in a homothetic manner.

In this way, in annular illumination, by using the action of the first and second V-grooved axicon systems 12 and 13, and the zoom lens 42, it is possible to change the overall size and shape (ring ratio) of the annular secondary light source, or to change the position, shape and size of the respective planar light sources constituting the bipolar secondary light source or quadrupolar secondary light source derived from this annular secondary light source. Moreover, in circular illumination, by using the action of the first and second V-grooved axicon system 12 and 13, and zoom lens 42, it is possible to change the overall size of the circular secondary light source, or to change the position, shape and size of the respective planar light sources constituting the bipolar secondary light source or quadrupolar secondary light source derived from the circular secondary light source.

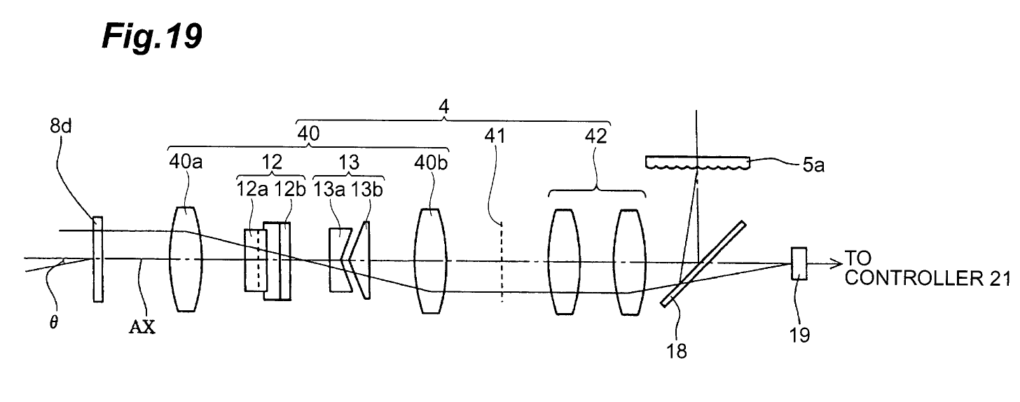

FIG. 19 is an approximate view of the principal composition of this embodiment. In this embodiment, as illustrated in FIG. 19, a half mirror 18 forming a light splitting member is disposed in the optical path between the zoom lens 42 and the micro lens array 5a. Of the light beam incident on the half mirror 18, the majority of the light beam is reflected by the half mirror 18 and forms an illumination field of a prescribed shape on the incident face of the micro lens array 5a, whilst the remainder of the light beam is transmitted through the half mirror 18 and is incident on a photoelectric converter element 19. A CCD or PSD (Position Sensitive Detector), or the like, may be used as the photoelectric converter element 19.

Here, the light receiving face of the photoelectric converter element 19 is disposed substantially in optical conjunction with the incident face of the micro lens array 5a. Therefore, the light beam split by the half mirror 18 forms a illumination field on the light receiving face of the photoelectric converter element 19 which is the same as the illumination field formed on the incident face of the micro lens array 5a. The output signal of the photoelectric converter element 19 is supplied to the control system 21. In FIG. 18, in order to simplify the diagram, the half mirror 18 and photoelectric converter element 19 are not illustrated, and the zoom lens 42 and micro lens array 5a are disposed along a linear optical axis, but in practice, the optical axis AX is deviated by the half mirror 18, as illustrated in FIG. 19.

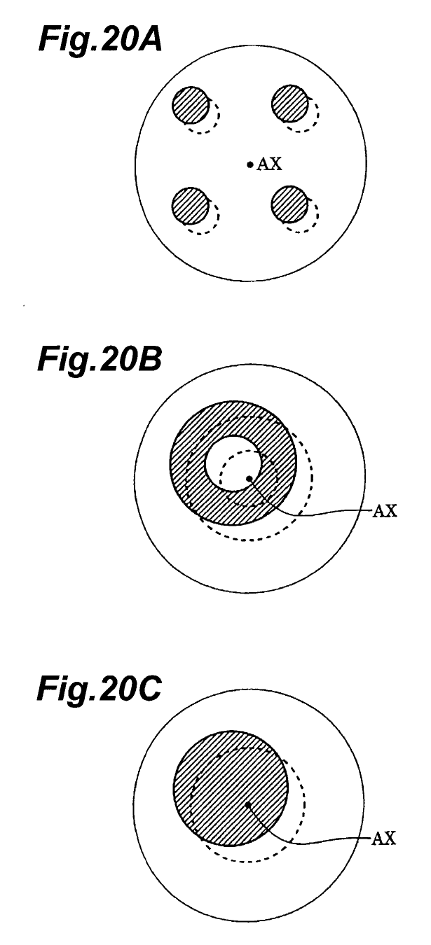

FIGS. 20A to 20C show states wherein a illumination field formed on the incident face of the micro lens array is shifted in position from the prescribed reference position. In this embodiment, if the central axis of the light beam from the light source 1 is inclined with respect to the reference optical axis AX of the illumination optical system 150 (from the beam expander 2 to the image formation optical system 16), in other words, if the central axis of the light beam is inclined with respect to the optical axis of the diffractive optical element 8a (as shown in FIG. 19), then as shown FIGS. 20A to 20C, the position of the illumination field formed on the incident face of the micro lens array 5a (as shown by the hatched region) will be displaced from the prescribed reference position (as shown by the broken line).

Consequently, the position of the secondary light source formed on the rear side focal plane of the micro lens array 5a is displaced from the prescribed reference position, and hence the telecentricity of the light beam at the mask M and the wafer W will be upset. More specifically, if the central axis of the light beam incident on the diffractive optical element 8n is inclined by an angle θ with respect to the reference optical axis AX, then taking the focal length of the zoom lens 42 as f, the displacement Δ of the illumination field from the reference position at the incident face of the micro lens array 5a can be expressed by follows.

θ=Δ/f

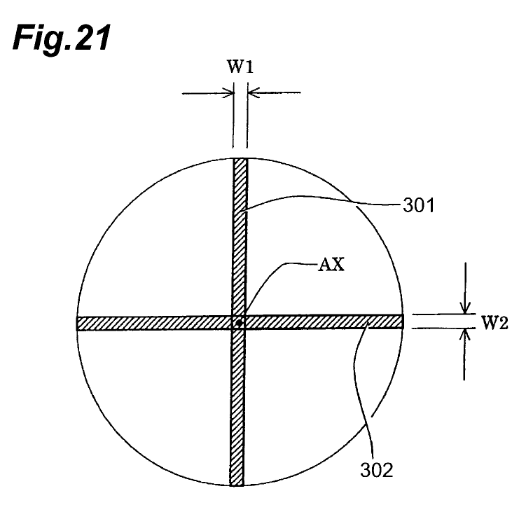

FIG. 21 shows a state where a cross-shaped shadow of low intensity is formed at the incident face of the micro lens array 5a, due to the ridge line portions of the pair of V-grooved axicon systems. Referring to FIG. 5, a vertical linear shadow (low intensity region) 301 caused by the first V-grooved axicon system 12 having a ridge line extending in the Z direction, and a horizontal linear shadow 302 caused by the second V-grooved axicon system 13 having a ridge line extending in the X direction, are formed on the incident face of the micro lens array 5a. Here, if the width W1 of the vertical shadow 301 is substantially different from the width W2 of the horizontal shadow 302, then the line width of the pattern transferred onto the wafer W will be different in the vertical direction and the horizontal direction.

In this embodiment, when the apparatus is being adjusted, the diffractive optical element 8d for adjustment is set in the illumination optical path, instead of the diffractive optical element 8a for quadrupolar illumination, the diffractive optical element 8b for annular illumination, or the diffractive optical element 8c for circular illumination. Here, the diffractive optical element 8d for adjustment has a similar function to the diffractive optical element 8a for quadrupolar illumination, the diffractive optical element 8b for annular illumination, or the diffractive optical element 8c for circular illumination, but it is set in such a manner that the size of the illumination field created on the incident face of the micro lens array 5a is smaller than is the case with the diffractive optical elements 8a to 8c. In other words, it is set in such a manner that a illumination field is created which corresponds with the light receiving face of the photoelectric converter element 19, which is substantially smaller than the incident face of the micro lens array 5a.

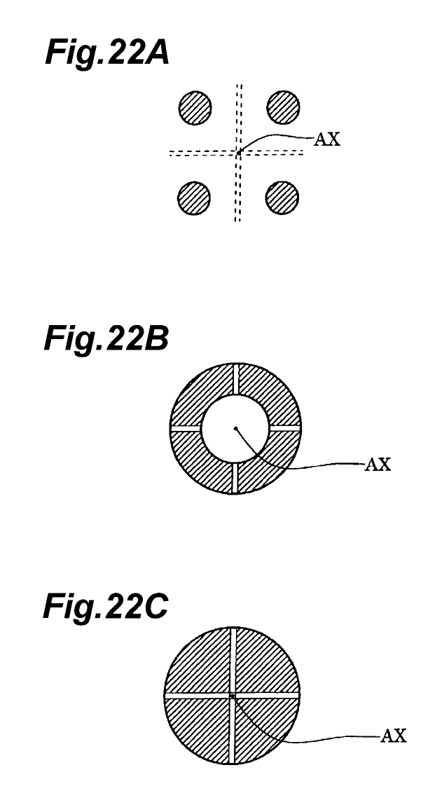

If a diffractive optical element for quadrupolar illumination is used as the diffractive optical element 8d for adjustment, then a quadrupolar illumination field such as that shown in FIG. 22A is formed on the light receiving face of the photoelectric converter element 19. In FIG. 22A, the hatched regions depict respective circular illumination fields constituting a quadrupolar illumination field, and the broken lines indicate a cross-shaped shadow formed by the ridge lines of the pair of V-grooved axicon systems 12 and 13. As shown in FIG. 22A, the quadrupolar illumination field formed on the light receiving face of the photoelectric converter element 19 is not affected in any way by the cross-shaped shadow.

In this way, if the focal length f of the zoom lens 42 is changed in a state where a diffractive optical element for quadrupolar illumination is set in the illumination optical path as a diffractive optical element 8d for adjustment, then if the optical axis of the zoom lens 42 does not coincide with the reference optical axis AX, the size of the quadrupolar illumination field formed on the light receiving face of the photoelectric converter element 19 will be enlarged or reduced, in a homothetic manner, and moreover, the position thereof will be displaced from the prescribed reference position. In other words, if the optical axis of the zoom lens 42 does not coincide with the reference optical axis AX, then the central position of the respective circular illumination fields will change as the focal length f of the zoom lens 42 changes.

Therefore, in this embodiment, the control system 21 determines the central position of the respective circular illumination fields formed on the light receiving face of the photoelectric converter element 19 on the basis of the output signal form the photoelectric converter element 19. The control system 21 then adjusts and drives the optical axis of the zoom lens 42 by means of the sixth drive system 27, for instance, in such a manner that the central position of the respective circular illumination fields does not change when the focal length f of the zoom lens 42 changes. As a result, the optical axis of the zoom lens 42 can be adjusted to coincide in position with the reference optical axis AX.

Thereupon, the control system 21 determines the positional relationship between the central position of the quadrupolar illumination field formed on the light receiving face of the photoelectric converter element 19 and a reference point on the light receiving face of the photoelectric converter element 19 (and consequently, the reference optical axis AX), on the basis of the output signal from the photoelectric converter element 19. The control system 21 then adjusts the position or direction of the light beam from the light source 1, by means of a light beam adjuster 28 (see FIG. 18), in such a manner that the central position of the quadrupolar illumination field coincides with the reference point on the light receiving face of the photoelectric converter element 19, in other words, in such a manner that the position at which the quadrupolar illumination field is formed coincides with the reference position thereof. Consequently, the central axis of the light beam from the light source 1 can be adjusted in position with respect to the reference optical axis AX.

The reference point on the light receiving face of the photoelectric converter element 19 is initially set to the central position of the quadrupolar illumination field formed on the light receiving face of the photoelectric converter element 19 in a state where the central position of the quadrupolar illumination field formed on the incident face of the micro lens array 5a has been adjusted so that it coincides with the reference optical axis AX. It is also possible to employ an automatic optical axis tracking mechanism built into the exposure apparatus, as a light beam adjuster for adjusting the position or direction of the light beam from the light source 1. Details of an automatic optical axis tracking mechanism can be found in U.S. Pat. No. 5,731,461, JP 11-145033A, JP 11-251220A, JP 2000-315639A, or the like. This U.S. Pat. No. 5,731,461 is incorporated by reference.

In the foregoing description, a diffractive optical element for quadrupolar illumination is used as a diffractive optical element 8d for adjustment, but the invention is not limited to this, and a diffractive optical element for annular illumination or a diffractive optical element for circular illumination may also be used for same. Here, if a diffractive optical element for annular illumination is used as the diffractive optical element 8d for adjustment, then an annular illumination field such as that shown in FIG. 22B will be formed on the light receiving face of the photoelectric converter element 19. In this case, the annular illumination field is affected by the cross-shaped shadow, but similarly to the case of the quadrupolar illumination field, the optical axis of the zoom lens 42 can be aligned with respect to the reference optical axis AX, whilst also aligning the central axis of the light beam from the light source 1 with the reference optical axis AX.

If, on the other hand, a diffractive optical element for circular illumination is used as the diffractive optical element 4d for adjustment, then a circular illumination field as illustrated in FIG. 22C, will be formed on the light receiving face of the photoelectric converter element 19. In this case, the circular illumination field is affected by the cross-shaped shadow, but similarly to the case of a quadrupolar illumination field and an annular illumination field, the optical axis of the zoom lens 42 can be aligned with respect to the reference optical axis AX, whilst also aligning the central axis of the light beam from the light source 1 with the reference optical axis AX.

If the diffractive optical element for quadrupolar illumination or the diffractive optical element for circular illumination is used as the diffractive optical element 4d for adjustment, then as shown in FIGS. 22B and 22C, the annular illumination field or circular illumination field formed on the light receiving face of the photoelectric converter element 19 is affected by the cross-shaped shadow. Therefore, in this embodiment, the control system 21 determines the width W1 of the vertical shadow and the width W2 of the horizontal shadow formed on the light receiving face of the photoelectric converter element 19, on the basis of the output signal from the photoelectric converter element 19, when a diffractive optical element for quadrupolar illumination or a diffractive optical element for circular illumination is set in the illumination path as the diffractive optical element 8d for adjustment.

The control system 21 then adjusts the intervals in the first and second V-grooved axicon system 12 and 13, by means of the fourth or fifth drive system 25 or 26, in such a manner that the width W1 of the vertical shadow and the width W2 of the horizontal shadow are matching. Consequently, it is possible to make the width W1 of the vertical shadow created by the first V-grooved axicon system 12 coincide with the width W2 of the horizontal shadow created by the second V-grooved axicon system 13. By changing the first or second V-grooved axicon system 12 or 13 according to requirements, it is possible to make the vertical shadow width W1 and the horizontal shadow width W2 coincide with each other.

The foregoing description centered on a case where the width W1 of the vertical shadow and the width W2 of the horizontal shadow are made to coincide, but it is also necessary to align the position of the vertical shadow and the position of the horizontal shadow with the reference optical axis AX. In this case, the control system 21 determines the position of the vertical shadow and the position of the horizontal shadow formed on the light receiving face of the photoelectric converter element 19, on the basis of the output signal from the photoelectric converter element 19. The control system 21 then drives and adjusts the first and second V-grooved axicon system 12 and 13, by means of the fourth or fifth drive system 25 or 26, for example, in order that the position of the vertical shadow and the position of the horizontal shadow are aligned with the reference optical axis AX.

The foregoing description also assumed that the light receiving face of the photoelectric converter element 19 is substantially smaller than the incident face of the micro lens array 5a, and hence a diffractive optical element 8d for adjustment is used when adjusting the device. However, if the light receiving face of the photoelectric converter element 19 can be set to a sufficiently large size, then it is possible to carry out device adjustment by using a diffractive optical element 8a or 8b for reshaped illumination, or a diffractive optical element 8c for normal illumination, rather than having to use a diffractive optical element 8d.

Moreover, in the foregoing description, the pair of V-grooved axicon systems 12 and 13 are disposed in the optical path of the afocal lens 40, but the invention is not limited to this, and various modifications may be applied to the present invention, for example, a modification wherein a conical axicon system is appended to the pair of V-grooved axicon systems, a modification wherein a conical axicon system is provided instead of one of the pair of V-grooved axicon systems, a modification wherein one V-grooved axicon system only is provided, or a modification wherein a conical axicon system is provided instead of the pair of V-grooved axicon systems, or the like.

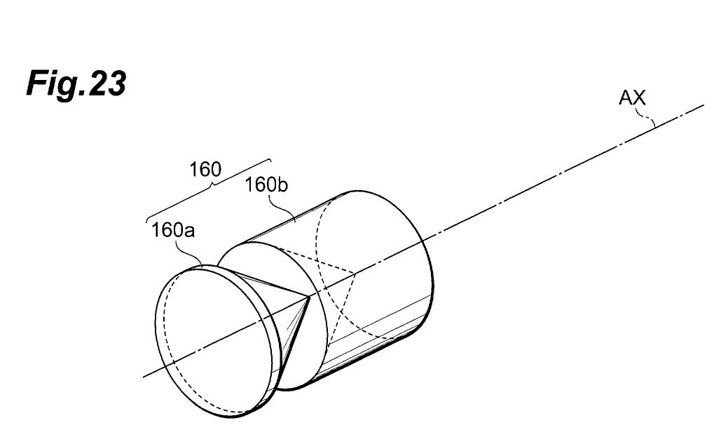

Such conical axicon system 160, as shown in FIG. 23, provided in the optical path of the afocal lens 40 is constituted by a first prism member 160a which has a planar face oriented towards the light source side and a conical concave refracting face oriented towards the mask side, and a second prism member 160b which has a planar face oriented towards the mask side and a convex conical refracting face oriented towards the light source side, said members 160a and 160b being disposed in said order from the light source side. The concave conical refracting face of the first prism member 160a and the convex conical refracting face of the second prism member 160b are formed in a complementary fashion, in such a manner that they can be fitted mutually. Moreover, at least one of the first prism member 160a and/or the second prism member 160b is composed movably along the optical axis AX, thereby achieving a composition wherein the interval in the conical axicon system 160 can be changed.

In this case, a spot-shaped shadow is formed on the incident face of the micro lens array 5a (and consequently, the light receiving face of the photoelectric converter element 19), due to the vertex portion of the conical axicon system 160 (the vertex of the concave conical refracting face and the vertex of the convex conical refracting face), but this spot-shaped shadow must be aligned in position with the reference optical axis AX. Therefore in this modification, the control system 21 determines the position of the spot-shaped shadow on the basis of the output signal from the photoelectric converter element 19. The control system 21 then drives and adjusts the conical axicon system 160 in order that the position of the spot-shaped shadow is aligned with the reference optical axis AX.

Furthermore, in a modification wherein only one V-grooved axicon system 12 or 13 is provided, a single linear shadow is formed on the incident face of the micro lens array 5a (and consequently on the light receiving face of the photoelectric converter element 19), and this linear shadow must be aligned in position with the reference optical axis AX. Therefore, in this modification, the control system 21 determines the position of the linear shadow on the basis of the output signal from the photoelectric converter element 19. The control system 21 then drives and adjusts the V-grooved axicon system 12 or 13 in order that the position of the linear shadow is aligned with the reference optical axis AX.

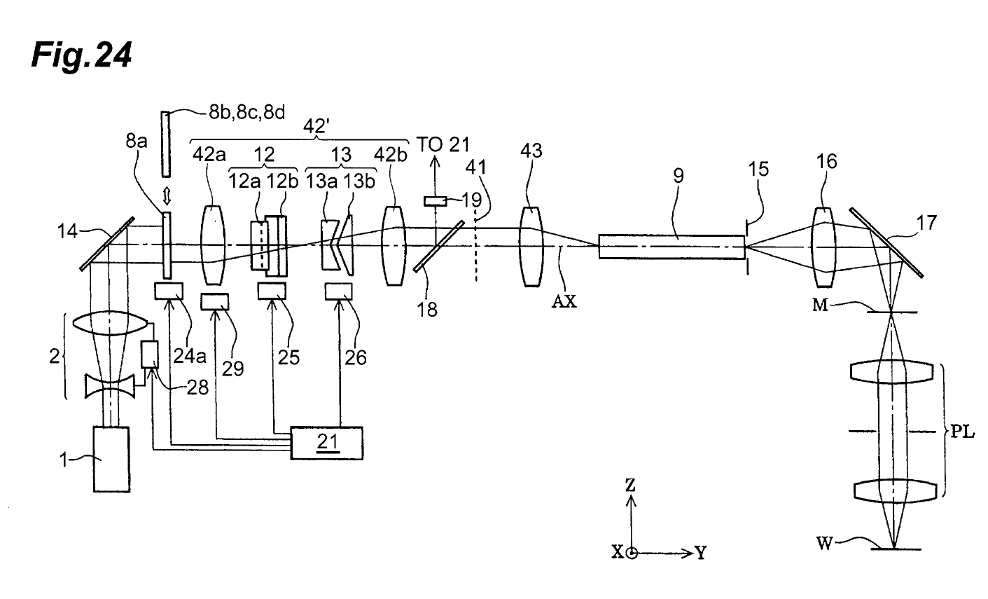

FIG. 24 shows the approximate composition of an exposure apparatus according to a sixth embodiment of the present invention. This sixth embodiment has a similar composition to the fifth embodiment. However, this embodiment differs essentially from the fifth embodiment in that it uses an internal reflection type optical integrator (rod type integrator 9) such as used in third embodiment, instead of the wavefront dividing type optical integrator (micro lens array 5a). Below, the sixth embodiment is described with particular attention to this difference with respect to the fifth embodiment.

In this embodiment, in accordance with the fact that a rod-shaped integrator 9 is provided instead of a micro lens array 5a, a zoom lens 42′ and an input lens 43 are disposed, in that order from the light source side, in the optical path between the diffractive optical element 8n and the rod-shaped integrator 9. A mask blind 15 for restricting the illumination field is also disposed in the vicinity of the output face of the rod-shaped integrator 9.

Here, the zoom lens 42′ is disposed in such a manner that the forward side focal position thereof substantially coincides with the position of the diffractive optical element 8n, and the rear side focal position thereof substantially coincides with the position of a designated plane 41 indicated by the broken line. The focal length of the zoom lens 42′ can be changed by means of a drive system 29 which is operated on the basis of commands from the control system 21. Moreover, the input lens 43 is disposed in such a manner that the forward side focal position thereof substantially coincides with the rear side focal position of the zoom lens 42′ (in other words, the position of the designated plane 41), and the rear side focal position thereof substantially coincides with the position of the incident face of the rod-shaped integrator 9.

The rod-shaped integrator 9 is an internal reflection type glass rod made from a glass material such as silica glass or fluorite, and by using total internal reflection at the interface between the interior and exterior of the rod, a number of light source images are formed in a parallel plane to the incident face of the rod passing through the focal point, said number of images corresponding to the number of internal reflections. Here, almost all of the light source images thus formed are virtual images, and only the central light source image (at the focal point) is a real image. In other words, the light beam entering the rod-shaped integrator 9 is divided in an angular direction by the total internal reflection, and a secondary light source consisting of a plurality of light source images is formed in a parallel plane to the incident plane which passes through the focal point.

Therefore, in the quadrupolar illumination (or annular illumination or circular illumination) according to the sixth embodiment, the light beam transmitted through a diffractive optical element 8a (8b or Bc) disposed selectively in the illumination optical path passes through a zoom lens 42′ and forms a quadrupolar (or annular or circular) illumination field at the rear side focal position thereof (in other words, the position of the designated plane 41). The light beam from the quadrupolar (or annular or circular) illumination field is focused by an input lens 43 to the vicinity of the incident face of the rod-shaped integrator 9.

In this way, the light beam from a quadrupolar (or annular or circular) secondary light source created on the input side of the rod-shaped integrator 9 is formed in an overlapping manner at the output face thereof, whereupon it passes through a mask blind 15 and image forming optical system 16 to illuminate a mask M formed with a prescribed pattern. In the sixth embodiment, a first and second V-grooved axicon system 12 and 13 are disposed, in that order from the light source side, in the optical path between the forward side lens group 42a of the zoom lens 42 and the rear side lens group 42b thereof.

Therefore, in the quadrupolar illumination according to the second embodiment, similarly to the first embodiment, by using a diffractive optical element 8a for quadrupolar illumination selectively, and using the actions of the first and second V-grooved axicon system 12, 13 and zoom lens 42′, the position, shape and size of the respective planar light sources constituting the quadrupolar secondary light source can be changed appropriately.

Moreover, in annular illumination according to the sixth embodiment, similarly to the fifth embodiment, by using a diffractive optical element 8b for annular illumination selectively, and using the actions of the first and second V-grooved axicon system 12 and 13, and zoom lens 42′, the overall size and shape (ring ratio) of the annular secondary light source, or the position, shape and size of the respective planar light sources constituting the bipolar secondary light source or quadrupolar secondary light source derived from the annular secondary light source, can be changed appropriately.

Furthermore, in circular illumination according to the sixth embodiment, similarly to the fifth embodiment, by using a diffractive optical element 8c for circular illumination selectively, and using the actions of the first, second V-grooved axicon system 12 and 13 and zoom lens 42′, the overall size of the circular secondary light source, or the position, shape and size of the respective planar light sources constituting the bipolar secondary light source or quadrupolar secondary light source derived from the circular secondary light source, can be changed appropriately.

In the sixth embodiment, a half mirror 18 is disposed as a light splitting member in the optical path between the designated plane 41 on which the illumination field is formed, and the zoom lens 42′, and the light beam split by the half mirror 18 is received by a photoelectric converter element 19. Here, the light receiving face of the photoelectric converter element 19 is disposed in optical conjunction with the designated plane 41 on which the illumination field is formed. Therefore, similar beneficial effects to those of the fifth embodiment can also be obtained in the sixth embodiment.

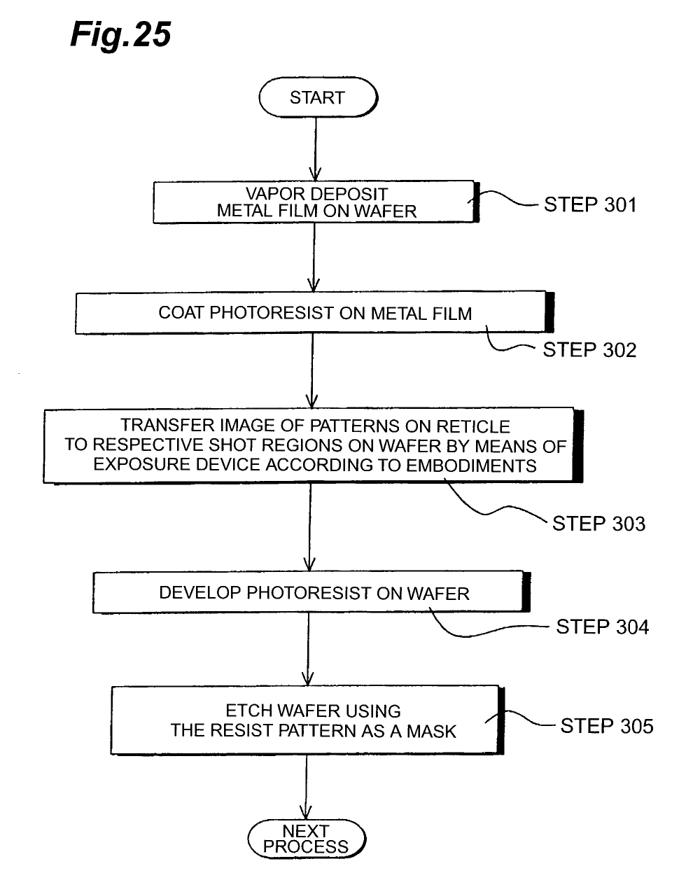

In the exposure apparatus relating to the respective embodiments described above, it is possible to fabricate micro devices (semiconductor elements, imaging elements, liquid crystal display elements, ultra-thin magnetic heads, and the like), by illuminating a mask (reticle) by means of an illumination optical device (illumination step), and exposing a transfer pattern formed on the mask onto a photosensitive substrate, by means of a projection optical system. Below, one example of a procedure for obtaining a semiconductor micro device, by forming a prescribed circuit pattern on a wafer, or the like, which is a photosensitive substrate, by means of an exposure apparatus according to the respective embodiments above, will be described with reference to the flowchart in FIG. 25.

Firstly, at step 301, a metal film is vapor deposited onto one lot of wafer. At the next step 302, a photoresist is coated onto the metal film on the wafer lot. Next, at step 303, using an exposure apparatus according to the foregoing embodiments, an image of a mask pattern is successively exposed and transferred onto respective shot regions of the wafer lot, by means of a projection optical system. Thereupon, at step 304, the photoresist on the wafer lot is developed, and at step 305, the wafer lot is etched, using the resist pattern as a mask, thereby creating a circuit pattern corresponding to the pattern on the mask in the respective shot regions of the respective wafers. By subsequently forming circuit pattern layers thereon, a semiconductor element, or other such device, can be fabricated. According to this semiconductor device fabrication method, it is possible to obtain semiconductor devices having an extremely fine circuit pattern with good throughput.

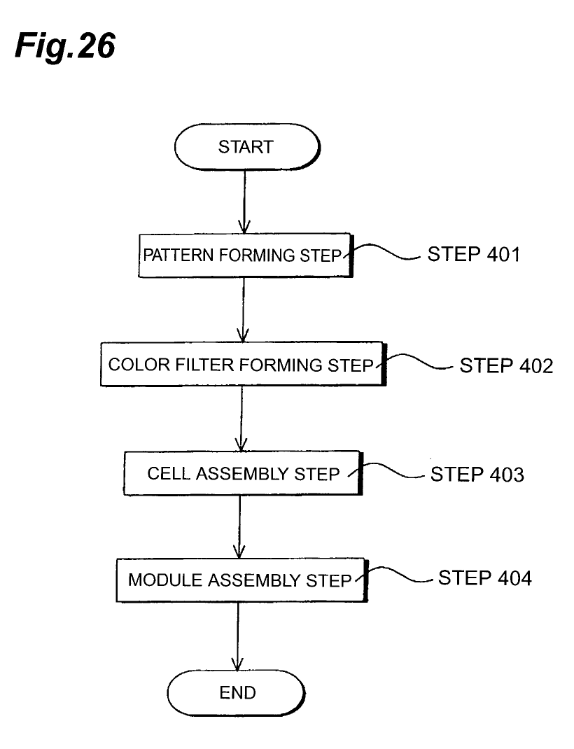

Moreover, in the exposure apparatus according to the respective embodiments described above, by forming a prescribed pattern (circuit pattern, electrode pattern, or the like) on a plate (glass substrate), it is also possible to obtain a liquid crystal display element as a micro device. Below, one example of a procedure relating to this is described with reference to the flowchart in FIG. 26. In this flowchart, at a pattern forming step 401, a so-called optical lithography step is carried out, whereby a mask pattern is transferred and exposed onto a photosensitive substrate (glass substrate coated with resist, or the like), using the exposure apparatus according to the respective embodiments described above. By means of this optical lithography process, a prescribed pattern comprising a plurality of electrodes, and the like, is formed on the photosensitive substrate. Thereupon, the exposed substrate is passed through a developing process, etching process and reticle separating process, and the like, whereby a prescribed pattern is formed on the substrate, and it then proceeds to the subsequent color filter forming step 402.

Next, at the color filter forming step 402, a multiplicity of groups of three dots corresponding to Red (R), Green (G) and Blue (B) are arranged in a matrix fashion, and a multiplicity of groups of three strip filters, R, G, B, are arranged in the direction of horizontal scanning lines, thereby forming a color filter. After the color filter forming step 402, a cell assembly process 403 is performed. In this cell assembly step 403, the substrate having the prescribed pattern obtained in the pattern forming step 401 is assembled with a liquid crystal panel (liquid crystal cell) using the color filter obtained at the color filter forming process 402, and the like. In the cell assembly step 403, for example, a liquid crystal panel (liquid crystal cell) is manufactured by injecting liquid crystal between the substrate having the prescribed pattern obtained in the pattern forming step 401 and the color filter obtained in the color filter forming step 402,

Thereupon, in a module assembly step 404, respective components, such as electrical circuits, a backlight, and the like for performing display operations in the assembled liquid crystal display panel (liquid crystal display cell), are installed, thereby completing the liquid crystal display element. According to the method of manufacturing a liquid crystal display element described above, it is possible to obtain an liquid crystal display element having a very fine circuit pattern, with a good throughput.

Also, although, in the embodiments described above, a KrF excimer laser that supplies light of wavelength 248 nm or an ArF excimer laser that supplies light of wavelength 193 nm were applied as the light source, it would be possible to employ as the light source laser light sources that supply light in the vacuum ultraviolet region such as an F₂ laser that supplies light of wavelength 157 nm, a Kr₂ laser that supplies light of wavelength 146 nm, or an Ar₂ laser that supplies light of wavelength 126 nm, or a lamp light source such as a very high pressure mercury lamp that supplies light such as g-line (436 nm) or i-line (365 nm).

In the respective embodiments above, the present invention was described by means of an example of an exposure apparatus provided with an illumination optical device, but it is evident that the present invention may also be applied to a general illumination optical device for illuminating an irradiated face other than a mask.

As described above, in an illumination optical device according to the present invention, it is possible to align the central axis of the light beam from a light source with respect to the reference optical axis of the optical system. Moreover, it is also possible to ensure that the width of the vertical shadow formed by one of the V-grooved axicon systems and the width of the horizontal shadow formed by the other of the V-grooved axicon systems are substantially the same. Consequently, it is possible to manufacture micro devices of good quality, in good illumination conditions, in an exposure apparatus incorporating the illumination optical device according to the present invention.

As described above, with the present invention exposure can be performed in accordance with optimum illumination conditions without dependence on the directionality of the fine pattern of the reticle. Specifically, by setting of the positional co-ordinate in the longitudinal direction and the positional co-ordinate in the transverse direction on the pupil plane (or plane in the vicinity thereof) of the four substantially planar light sources to be substantially different, the substrate pattern (wafer pattern) that is formed by the transferred resist pattern or processing (wafer processing) can be formed in the desired size and shape.

Also, in the case where the reticle has a plurality of chip patterns, exposure can be performed under optimum illumination conditions without dependence on the directionality of the fine pattern on the reticle by setting at least one of the positional co-ordinate in the longitudinal direction and the positional co-ordinate in the transverse direction of the four substantially planar light sources such that the positional co-ordinate in the longitudinal direction and the positional co-ordinate in the transverse direction are substantially different, in accordance with the direction of the long side of the chip patterns.

What is claimed is:

1. An exposure apparatus for transferring a pattern of a mask onto a workpiece, comprising:
a light source;
an illumination optical system, which illuminates said mask, arranged in an optical path between said light source and said mask and comprising a pupil shape forming unit which forms four substantially planar light sources at a predetermined plane orthogonal to the illumination optical path in the vicinity of the pupil thereof,
wherein said four planar light sources are arranged at each substantial vertices of a narrow rectangle whose barycenter is located on the optical axis so as to adjust a resist pattern to be transferred or a substrate pattern formed via a process to a predetermined size and a predetermined shape; and
a projection optical system arranged in an optical path between said mask and said workpiece.

2. The exposure apparatus according to claim 1, wherein said mask is provided with an optical proximity correction, and said pupil shape forming unit is capable of changing the shape of the narrow rectangle so as to further correct at least one of the longitudinal line width and a transverse line width of the resist pattern which is obtained from said mask with the optical proximity correction.

3. The exposure apparatus according to claim 1, wherein a ratio between longer side and shorter side of said rectangle is 1.1 or more.

4. The exposure apparatus according to claim 1, wherein each of said four substantially planar light sources has circular shape.

5. The exposure apparatus according to claim 1, wherein said pupil shape forming unit has an aperture stop, disposed on the illumination optical path, that restricts a light beam passing therethrough.

6. The exposure apparatus according to claim 5, wherein said pupil shape forming unit has a plurality of aperture stops which are removable from and insertable in the illumination optical path.

7. The exposure apparatus according to claim 1, wherein said pupil shape forming unit has a diffractive optical element, disposed on the illumination optical path, which converts a light beam into a light beam with a predetermined cross section.

8. The exposure apparatus according to claim 7, wherein said pupil shape forming unit has a plurality of diffractive optical elements which are removable from and insertable in the illumination optical path.

9. An exposure apparatus for transferring a pattern of a mask onto a workpiece, comprising:
a light source;
an illumination optical system, which illuminates said mask with a plurality of chip patterns to be transferred, arranged in an optical path between said light source and said mask and comprising a pupil shape forming unit which forms four substantially planar light sources at a predetermined plane orthogonal ton the illumination optical path in the vicinity of the pupil thereof,
wherein said four planar light sources are arranged at each substantial vertices of a narrow rectangle whose barycenter is located on the optical axis,
and at least one of a longer side of said narrow rectangle and a shorter side of said narrow rectangle is set based on a longer direction of said chip pattern; and
a projection optical system, which projects and transfers the chip patterns of the mask onto said workpiece, arranged in an optical path between said mask and said workpiece.

10. The exposure apparatus according to claim 9, wherein said pupil shape forming unit adjusts the four planar light sources so as to set a resist pattern to be transferred or a substrate pattern formed via a process to a predetermined size and a predetermined shape.

11. The exposure apparatus according to claim 9, wherein said pupil shape forming unit is capable of changing the shape of the narrow rectangle so as to further correct at least one of the longitudinal line width and a transverse line width of the resist pattern or the substrate pattern which is obtained from the mask with the optical proximity correction.

12. The exposure apparatus according to claim 9, wherein a ratio between longer side and shorter side of said rectangle is 1.1 or more.

13. The exposure apparatus according to claim 9, wherein each of said four substantially planar light sources has circular shape.

14. The exposure apparatus according to claim 9, wherein said pupil shape forming unit has an aperture stop, disposed on the illumination optical path, which restricts a light beam passing therethrough.

15. The exposure apparatus according to claim 14, wherein said pupil shape forming unit has a plurality of aperture stops which are removable from and insertable in the illumination optical path.

16. The exposure apparatus according to claim 9, wherein said pupil shape forming unit has a diffractive optical element, disposed on the illumination optical path, which converts a light beam into a light beam with a predetermined cross section.

17. The exposure apparatus according to claim 16, wherein said pupil shape forming unit has a plurality of diffractive optical elements which are removable from and insertable in the illumination optical path.

18. A method of exposure comprising the steps of:
illuminating a mask with a pattern to be transferred through an illumination optical system, having a step of:
forming four substantially planar light sources at a predetermined plane orthogonal to the illumination optical path in the vicinity of the pupil of the illumination optical system; and
adjusting the pattern projected onto the workpiece or a substrate pattern formed via a process as a desired size and shape by arranging said four planar light sources at each substantial vertices of a narrow rectangle whose barycenter is located on an optical axis; and
projecting and transferring the pattern of the mask onto a workpiece.

19. The method according to claim 18, wherein the mask is provided with an optical proximity correction, and the method further comprising a step of changing the shape of said narrow rectangle so as to further correct at least one of the longitudinal line width and a transverse line width of the resist pattern which is obtained from said mask with the optical proximity correction.

20. The method according to claim 18, wherein a ratio between longer side and shorter side of said rectangle is 1.1 or more.

21. The method according to claim 19, wherein a ratio between longer side and shorter side of said rectangle is 1.1 or more.

22. A method of exposure comprising the steps of:
illuminating a mask with a plurality of chip patterns through an illumination optical system, having the steps of:
forming four substantially planar light sources at a predetermined plane orthogonal to the illumination optical path in the vicinity of the pupil of the illumination optical path; and
arranging said four planar light sources at each substantial vertices of a narrow rectangle whose barycenter is located on the optical axis, wherein at least one of the longer side of said narrow rectangle and shorter side of said narrow rectangle is set based on a longer direction of said chip pattern; and
projecting and transferring the chip patterns on this mask onto a workpiece.

23. The method according to claim 22, wherein said illuminating process having a step of setting the four planar light sources so as to set a resist pattern to be transferred or a substrate pattern formed via a process to a predetermined size and a predetermined shape.

24. The method according to claim 22, wherein said mask is provided with an optical proximity correction, and the method further comprising a step of changing the shape of said narrow rectangle so as to further correct at least one of a longitudinal line width and a transverse line width of the resist pattern or the substrate pattern which is obtained from the mask with the optical proximity correction.

25. The method according to claim 22, wherein a ratio between longer sides and shorter sides of said rectangle is 1.1 or more.

26. An exposure apparatus comprising:
a light source;
an illumination optical system, arranged in an optical path between said light source and a mask with a pattern to be transferred, that illuminates the mask, and comprising a pupil shape forming unit which forms four substantially planar light sources at a predetermined plane orthogonal to the illumination optical path in the vicinity of the pupil thereof; and
a projection optical system, arranged in an optical path between said mask and a workpiece, which projects and transfers the pattern of said mask onto the workpiece, and
wherein said pupil shape forming unit has a first illumination mode and a second illumination mode for arranging said four planar light sources,
in said first illumination mode, said four planar light sources are arranged at each substantial vertices of a narrow rectangle having barycenter located on the optical axis, longer sides arranged along a predetermined direction, and a ratio between longer side and shorter side of the narrow rectangle of 1.1 or more, and
in second illumination mode, said four planar light sources are arranged at each substantial vertices of another narrow rectangle having barycenter located on the optical axis, shorter sides arranged along said predetermined direction, and a ratio between shorter side and longer side of 1/1.1 or less.

27. The exposure apparatus according to claim 26, wherein the ratio between longer side and shorter side of said rectangle in said first illumination mode is 1.2 or more, and wherein the ratio between shorter side and longer side of said another rectangle in said second illumination mode is 1/1.2 or less.

28. The exposure apparatus according to claim 26, wherein a ratio σs between the respective numerical apertures of the four light beams from said four substantially planar light sources and the numerical aperture on the mask side of said projection optical system is within the range of 0.1 and 0.3 inclusive.

29. The exposure apparatus according to claim 27, wherein a ratio σs between the respective numerical apertures of the four light beams from said four substantially planar light sources and the numerical apertures on the mask side of said projection optical system is within the range of 0.1 and 0.3 inclusive.

30. A method of exposure comprising the steps of:
illuminating a mask with a pattern through an illumination optical system; and
projecting and transferring the pattern on the mask onto a workpiece,
wherein said illuminating step comprising the steps of:
forming four substantially planar light sources at a predetermined plane orthogonal to the illumination optical path in the vicinity of a pupil of the illumination optical system; and
arranging said four substantially planar light sources on said predetermined plane as a first or second illumination mode,
in said first illumination mode, said four planar light sources are arranged at each substantial vertices of a narrow rectangle having barycenter located on the optical axis, longer sides arranged along the predetermined direction, and a ratio between longer sides and shorter sides of 1.1 or more, and
in second illumination mode, said four planar light sources are arranged at each substantial vertices of another narrow rectangle having barycenter located on the optical axis, shorter sides arranged along said predetermined direction, and a ratio between shorter sides and longer sides of 1/1.1 or more.

31. The method according to claim 30, wherein the ratio between longer side and shorter side of said rectangle in said first illumination mode is 1.2 or more, and wherein the ratio between shorter side and longer side of said another rectangle in said second illumination mode is 1/1.2 or less.

32. The method according to claim 30, wherein a ratio as between the respective numerical apertures of the four light beams from said four substantially planar light sources and the numerical apertures on the mask side of the projection optical system is within the range of 0.1 and 0.3 inclusive.

33. The method according to claim 31, wherein the ratio σs between the respective numerical apertures of the four light beams from said four substantially planar light sources and the numerical apertures on the mask side of said projection optical system is within the range of 0.1 and 0.3 inclusive.

34. An exposure apparatus comprising:
a light source;
an illumination optical system, arranged in an optical path between said light source and a mask with a pattern to be transferred, which illuminates said mask; and
a projection optical system, arranged in an optical path between the mask and a workpiece, which projects and transfers the pattern of said mask on said workpiece,
wherein said illumination optical system comprises a pupil shape forming unit, arranged in an illumination optical path, which forms four substantially planar light sources at a predetermined plane orthogonal to the illumination optical path in the vicinity of the pupil thereof, and arranges said four substantially planar light sources at each substantial vertices of a narrow rectangle whose barycenter is located on the optical axis as first and second illumination modes,
in said first illumination mode, one barycenter position of said four substantially planar light sources (r, θ) in polar coordinates whose origin is located at illumination optical axis, and r is normalized with a pupil radius of the projection optical system as 1, is satisfied following conditions,
0.5<r<1−rs
sin⁻¹{(rs)/(1−rs)}<θ<Π/4
where rs is the distance from the barycenter position of said one planar light source to the outermost circumferential edge, and
in said second illumination mode, one barycenter position of said f our substantially planar light sources (r, θ) in polar coordinates whose origin is located at illumination optical axis, and r is normalized with a pupil radius of the projection optical system as 1, is satisfied following conditions,
0.5<r<1−rs
Π/4<θ<Π/2−sin⁻¹{(rs)/(1−rs)}

35. The exposure apparatus according to claim 34, wherein said four substantially planar light sources are arranged with second-order rotational symmetry about a center of said optical axis on said predetermined plane.

36. A method of exposure comprising the steps of;
illuminating a mask with a pattern through an illumination optical system; and
projecting and transferring the pattern on said mask onto a workpiece,
wherein said illuminating step comprising steps of:
forming four substantially planar light sources at a predetermined plane orthogonal to the illumination optical path in the vicinity of the pupil of the illumination optical path; and
arranging said four substantially planar light sources at each substantial vertices of a narrow rectangle whose barycenter is located on the optical axis as first and second illumination modes,
in said first illumination mode, one barycenter position of said four substantially planar light sources (r, θ) in polar coordinates whose origin is located at illumination optical axis, and r is normalized with a pupil radius of the projection optical system as 1, is satisfied following conditions,
0.5<r<1−rs
sin⁻¹{(rs)/(1−rs)}<θ<Π/4
where rs is the distance from the barycenter position of said one planar light source to the outermost circumferential edge, and
in said second illumination mode, one barycenter position of said four substantially planar light sources (r, θ) in polar coordinates whose origin is located at illumination optical axis, and r is normalized with a pupil radius of the projection optical system as 1, is satisfied following conditions,
0.5<r<1−rs
Π/4<θ<Π/2−sin⁻¹{(rs)/(1−rs)}.

37. An illumination optical apparatus comprising:
an optical integrator arranged in an illumination optical path and forming a large number of light sources on the basis of a light beam from a light source;
a guiding optical system arranged in an illumination optical path between the optical integrator and a irradiated face and directing a light beam from said optical integrator to an irradiated face;
a illumination field forming optical system, which includes a light beam converting element disposed in the optical path between said light source and said optical integrator which converts the light beam from said light source to light beam having a predetermined cross-sectional shape or a predetermined light intensity distribution, forming a illumination field with a predetermined positional relationship with respect to said optical integrator in response to the light beam emitted from said light beam converting element;
a light splitting member disposed on the optical path between said predetermined plane and said light beam converting element;
a photoelectric converter element disposed on substantial conjugate plane of said predetermined plane and receiving light beam split by said light splitting member; and
a calculating unit, connected to said photoelectric converter element, and which determines a positional relationship between the light beam from said light source and said predetermined plane in response to the output of said photoelectric converter element.

38. The illumination optical apparatus according to claim 37, wherein said illumination field forming optical system further comprises a variable magnifying optical system which changes a size of the illumination field formed on said predetermined plane.

39. The illumination optical apparatus according to claim 37, wherein said illumination field forming optical system further comprises a first V-grooved axicon system having a ridge line extending in a first direction.

40. The illumination optical apparatus according to claim 39, wherein said illumination field forming optical system further comprises at least one of a conical axicon system having a conical refracting surface and a second V-grooved axicon system having a ridgeline extending in a second direction orthogonal to said first direction.

41. The illumination optical apparatus according to claim 37, wherein said light beam converting element comprises a plurality of diffractive optical elements which are removable and insertable in the illumination optical path.

42. The illumination optical apparatus according to claim 41, wherein at least one of said diffractive optical elements is used for an adjustment of said illumination optical apparatus.

43. The illumination optical apparatus according to claim 37, wherein said optical integrator has a wavefront dividing optical integrator with lens elements arrayed two-dimensionally, whose incident face is disposed at the position of said predetermined plane, or a position in the vicinity thereof.

44. An exposure apparatus comprising:
the illumination optical device according to claim 37; and
a projection optical system arranged in an optical path between a mask set on the irradiated face and an image surface of the mask and transferring the pattern of the mask onto a workpiece.

45. The exposure apparatus according to claim 44, further comprising a light beam adjusting unit disposed in the optical path between said light source and said beam splitting member and adjusting a position or direction of the light beam from said light source.

46. A method of manufacturing micro devices, comprising the steps of:
exposing the mask pattern onto a workpiece with the exposure apparatus according to claim 44; and
developing said workpiece which has been exposed by said exposing step.
